(19) United States
(12) Patent Application Publication
(10) Pub. No.: US 2026/0301463 A1
(43) Pub. Date: Oct. 1, 2026

(54) IMAGE PROCESSING METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Zheming HONG, Shenzhen (CN); Jun WANG, Shenzhen (CN); Shaoming WANG, Shenzhen (CN); Runzeng GUO, Shenzhen (CN); Jinkun HOU, Shenzhen (CN)

(21) Appl. No.: 19/677,860

(22) Filed: May 14, 2026

Related U.S. Application Data
(63) Continuation of application No. PCT/CN2025/080966, filed on Mar. 6, 2025.

(30) Foreign Application Priority Data
Mar. 11, 2024 (CN) 202410273571.6

(51) Int. Cl. G06V 40/16; G06V 10/10; G06V 10/147; G06V 10/24; G06V 40/12

(52) U.S. Cl. CPC G06V 40/172; G06V 10/147; G06V 10/16; G06V 10/247; G06V 40/1365

(57) ABSTRACT

An image processing method includes obtaining an original image pair, the original image pair including a first original image acquired by a first-type image acquisition device and a second original image acquired by a second-type image acquisition device, and both the first original image and the second original image including a target object; performing image cropping on the first original image to obtain a first cropped image, and performing image cropping on the second original image to obtain a second cropped image; performing distortion correction processing on the first cropped image to obtain a first distortion-corrected image, and performing distortion correction processing on the second cropped image to obtain a second distortion-corrected image; and performing distortion-aware spatial alignment on the first distortion-corrected image and the second distortion-corrected image to obtain a spatially aligned image including the target object.

### CROSS-REFERENCES TO RELATED APPLICATIONS

This application is a continuation application of PCT Patent Application No. PCT/CN 2025/080966, filed on Mar. 6, 2025, which is based on and claims priority to Chinese Patent Application No. 202410273571.6, filed on Jan. 11, 2024, all of which is incorporated herein by reference in their entirety.

### FIELD OF THE TECHNOLOGY

The present disclosure relates to the field of the Internet, and in particular, but is not limited to, an image processing method and apparatus, an electronic device, a computer-readable storage medium, and a computer program product.

### BACKGROUND OF THE DISCLOSURE

Image acquisition devices with dual cameras have become very common in the configuration of smart devices, especially in the fields of biometric information acquisition and recognition. For example, dual-camera image acquisition devices are widely applied to face scanning and palm scanning scenarios. To accurately recognize biometric information, it is necessary to combine image information captured by both cameras. However, due to issues such as positioning and assembly errors in external structure of a camera module or errors introduced during image capture, images obtained by the dual cameras may fail to align properly.

When aligning images captured by dual cameras, for example, in a face scanning scenario, spatial alignment is typically performed among three types of images: color images, infrared images, and depth images. In a palm scanning scenario, alignment is typically performed between color images and infrared images according to fixed positions, or dynamic alignment is performed between a color image and an infrared image based on a depth distance from a proximity sensor (PSensor).

However, such image alignment methods suffer from issues such as poor alignment effect and small effective Field of View (FOV), resulting in a limited usable distance range for palm scanning.

### SUMMARY

One embodiment of the present disclosure provides an image processing method, executed by an electronic device. The method includes obtaining an original image pair, the original image pair including a first original image acquired by a first-type image acquisition device and a second original image acquired by a second-type image acquisition device, and both the first original image and the second original image including a target object; performing image cropping on the first original image to obtain a first cropped image, and performing image cropping on the second original image to obtain a second cropped image; performing distortion correction processing on the first cropped image to obtain a first distortion-corrected image, and performing distortion correction processing on the second cropped image to obtain a second distortion-corrected image; and performing distortion-aware spatial alignment on the first distortion-corrected image and the second distortion-corrected image to obtain a spatially aligned image including the target object.

Another embodiment of the present disclosure provides an electronic device. The electronic device includes one or more processors and a memory containing executable instructions that, when being executed, cause the one or more processors to perform: obtaining an original image pair, the original image pair including a first original image acquired by a first-type image acquisition device and a second original image acquired by a second-type image acquisition device, and both the first original image and the second original image including a target object; performing image cropping on the first original image to obtain a first cropped image, and performing image cropping on the second original image to obtain a second cropped image; performing distortion correction processing on the first cropped image to obtain a first distortion-corrected image, and performing distortion correction processing on the second cropped image to obtain a second distortion-corrected image; and performing distortion-aware spatial alignment on the first distortion-corrected image and the second distortion-corrected image to obtain a spatially aligned image including the target object.

Another embodiment of the present disclosure provides a non-transitory computer-readable storage medium containing executable instructions that, when being executed, cause at least one processor to perform: obtaining an original image pair, the original image pair including a first original image acquired by a first-type image acquisition device and a second original image acquired by a second-type image acquisition device, and both the first original image and the second original image including a target object; performing image cropping on the first original image to obtain a first cropped image, and performing image cropping on the second original image to obtain a second cropped image; performing distortion correction processing on the first cropped image to obtain a first distortion-corrected image, and performing distortion correction processing on the second cropped image to obtain a second distortion-corrected image; and performing distortion-aware spatial alignment on the first distortion-corrected image and the second distortion-corrected image to obtain a spatially aligned image including the target object.

### BRIEF DESCRIPTION OF THE DRAWINGS

FIG. 1 is a schematic diagram of an effective FOV and an independent FOV according to an embodiment of the present disclosure;

FIG. 2 is a schematic diagram of an exemplary architecture of an image processing system according to an embodiment of the present disclosure;

FIG. 3 is a schematic structural diagram of an electronic device according to an embodiment of the present disclosure;

FIG. 4 is an exemplary schematic flowchart of an image processing method according to an embodiment of the present disclosure;

FIG. 5 is another exemplary schematic flowchart of an image processing method according to an embodiment of the present disclosure;

FIG. 6 is a schematic implementation flowchart of an image processing method according to an embodiment of the present disclosure;

FIG. 7 is a schematic diagram of an implementation principle of performing image processing in a center-aligned manner according to an embodiment of the present disclosure;

FIG. 8 is another schematic implementation flowchart of an image processing method according to an embodiment of the present disclosure;

FIG. 9 is still another exemplary schematic flowchart of an image processing method according to an embodiment of the present disclosure;

FIG. 10 is a schematic flowchart of an implementation method of distortion correction processing according to an embodiment of the present disclosure;

FIG. 11 is a schematic flowchart of obtaining an effective FOV in a palm recognition field;

FIG. 12 is a schematic flowchart of a method for optimizing an effective palm-scanning FOV of a camera in the palm recognition field according to an embodiment of the present disclosure;

FIG. 13a is a schematic diagram of a result of full-size FOV resolution using an unconventional ratio in an effective image cropping stage according to an embodiment of the present disclosure;

FIG. 13b is a schematic diagram of another result of full-size FOV resolution using an unconventional ratio in an effective image cropping stage according to an embodiment of the present disclosure;

FIG. 13c is a schematic diagram of still another result of full-size FOV resolution using an unconventional ratio in an effective image cropping stage according to an embodiment of the present disclosure;

FIG. 14 is a schematic diagram illustrating non-alignment of cameras in a vertical direction according to an embodiment of the present disclosure;

FIG. 15 is a schematic diagram of a result of random deviation of cameras according to an embodiment of the present disclosure;

FIG. 16 is a schematic diagram of lateral loss analysis according to an embodiment of the present disclosure;

FIG. 17 is a schematic diagram of comparison between alignment toward a color image and centering alignment according to an embodiment of the present disclosure;

FIG. 18 is a schematic comparison diagram of results of alignment toward different directions according to an embodiment of the present disclosure;

FIG. 19 is a schematic diagram of an arc-shaped region for distortion correction according to an embodiment of the present disclosure;

FIG. 20 is a schematic diagram of a comparison result between a normal procedure and direct spatial alignment based on distortion-corrected original images according to an embodiment of the present disclosure;

FIG. 21a is an overall schematic flowchart of an image processing method before optimization according to an embodiment of the present disclosure; and

FIG. 21b is an overall schematic flowchart of an image processing method that optimizes an FOV according to an embodiment of the present disclosure.

### DESCRIPTION OF EMBODIMENTS

To make the objectives, technical schemes, and advantages of the present disclosure clearer, the following describes the present disclosure in further detail with reference to the accompanying drawings. The described embodiments are not intended to limit the present disclosure. All other embodiments obtained by a person of ordinary skill in the art without creative efforts shall fall within the protection scope of the present disclosure.

In the following descriptions, “some embodiments” means a subset of all possible embodiments. However, “some embodiments” may be a same subset or different subsets of all the possible embodiments, and may be combined with each other without conflict. Unless otherwise defined, meanings of all technical and scientific terms used in the embodiments of the present disclosure are the same as those commonly understood by a person skilled in the art to which the embodiments of the present disclosure belong. Terms used in embodiments of the present disclosure are merely intended to describe objectives of embodiments of the present disclosure, but are not intended to limit the present disclosure.

In the embodiment of the present disclosure, the term “module” or “unit” refers to a computer program with a preset function or a part of the computer program, which works together with other related parts to implement a preset target, and may be completely or partially implemented by using software, hardware (for example, a processing circuit or a memory) or a combination thereof. Similarly, one processor (or a plurality of processors or memories) may be configured to realize one or more modules or units. In addition, each module or unit may be a part of an overall module or unit including the module or unit function.

Before the image processing method provided by the embodiments of the present disclosure is described, professional terms in the embodiments of the present disclosure are first described.

(1) Palm region detection: it refers to a process of positioning finger gap points by using a target detection technology, and accurately identifying a position and a boundary of a palm from a captured picture, so as to extract a palm print region picture according to the identified position and boundary. A palm detection model used during palm region detection may adopt an encoder-decoder architecture combined with cross-layer connections to extract multi-scale features, so as to perform palm region detection. Such an encoder-decoder architecture can effectively handle complexity and diversity of palms, including issues such as different sizes, occlusion, and self-occlusion. After a palm region is detected, a key point detection model further analyzes the palm region, to predict 21 2.5-dimensional hand key points. The key points include a wrist, as well as a root knuckle and a fingertip of each finger. The key point detection model can not only detect positions of the key points, but also distinguish a left hand from a right hand and provide confidence information.

(2) Palm print recognition: it refers to recognizing identity information of different users by analyzing features such as lines, wrinkles, and fine textures on a palm according to a palm print region picture. The palm print recognition technology may be implemented based on the following methods: a point and line feature-based method (extracting point and line features in a palm print, such as ridge endings and bifurcation points), a texture-based method (analyzing texture features of a palm print by using methods such as Gabor filtering and wavelet transform), a subspace-based method (extracting features by using a method such as principal component analysis or linear discriminant analysis), and feature fusion (combining multiple feature extraction methods to improve recognition accuracy and robustness). The palm print recognition technology is widely applied to the field of identity authentication and recognition, including but not limited to the following application scenarios: access control systems, attendance systems, financial fields, and information security fields.

(3) Cross-device registration and recognition: it refers to separately performing registration and recognition on two devices having a large difference, for example, registration on a mobile phone and recognition on an Internet of Things device. The cross-device registration and recognition technology has important applications in fields such as multi-device collaboration, identity authentication, and personalized services. The core of the cross-device registration and recognition technology lies in how to implement consistent identity authentication on different devices while ensuring data security and privacy. Methods of the cross-device registration and recognition technology include: device identifier (performing identity authentication on different devices by generating a unique device identifier), biometric recognition (performing identity authentication on different devices by using biological features (such as fingerprint, palm print, and face recognition)), and radio frequency fingerprint recognition (performing identity authentication by using a radio frequency fingerprint of a device, where a unique fingerprint is generated based on hardware characteristics of the device). The cross-device registration and recognition technology may be applied to at least the following scenarios: smart home (for implementing seamless collaboration between smart devices by using a unified device identification system), identity authentication (for performing identity authentication on different devices to improve user experience and security), and data sharing (for implementing efficient data sharing between devices to improve multi-device collaboration efficiency).

(4) Color image: it refers to a color image formed by natural light collected by a color sensor, and generally includes information about three color channels: red (R), green (G), and blue (B). The color image is generally used for face/palm selection, comparison, and recognition in face/palm-scanning payment. For face/palm selection, a face or palm region can be quickly recognized and located by using a color image system, so as to select an optimal recognition region. In addition, since the color image provides rich texture and color information, it helps improve recognition accuracy and reliability. Comparison and recognition means that in face-scanning or palm-scanning payment, a color image is used for comparison with a pre-registered image to verify a user identity. Since the color image can provide detailed visual information, it helps the system to perform identity authentication more accurately, thereby reducing the possibility of misrecognition. For example, in a face-scanning payment scenario, a color image is used for quickly locating a face region, and is compared with a registered image to complete identity authentication. For another example, in palm-scanning payment, a color image is used for identifying a texture and a shape of a palm, and is compared with a registered palm image, to ensure payment security.

(5) Infrared image: it refers to an infrared image formed by general infrared light collected by an infrared sensor, and is usually used for living body detection in face-scanning/palm-scanning payment. The infrared image is generated by capturing infrared rays radiated from the surface of a human body, and has depth information. Compared with a visible-light image, an infrared image can better reflect a three-dimensional structure and subtle changes of a face or a palm, such as tiny concaves and convexes on the skin surface, and blood flow changes. An infrared image is insensitive to lighting conditions, can work normally at night or in a dark environment, and can effectively distinguish a real face from forgery means such as photos and videos. In face-scanning payment and palm-scanning payment, an infrared image is used to detect whether a user is a real living body, thereby improving payment security.

(6) Selection: it refers to selecting a group of color images, depth images, or infrared images that meet preconditions of algorithms for living body detection, comparison, and recognition (in a face scanning/recognition scenario: color images, depth images, or infrared images; and in a palm scanning/recognition scenario: color images or infrared images). The color images may be selected based on indexes such as a face/palm angle, a size, a centering degree, and a color image definition; the infrared images may be selected based on indexes such as infrared image brightness; the depth images may be selected based on indexes such as depth image (face-scanning) integrity.

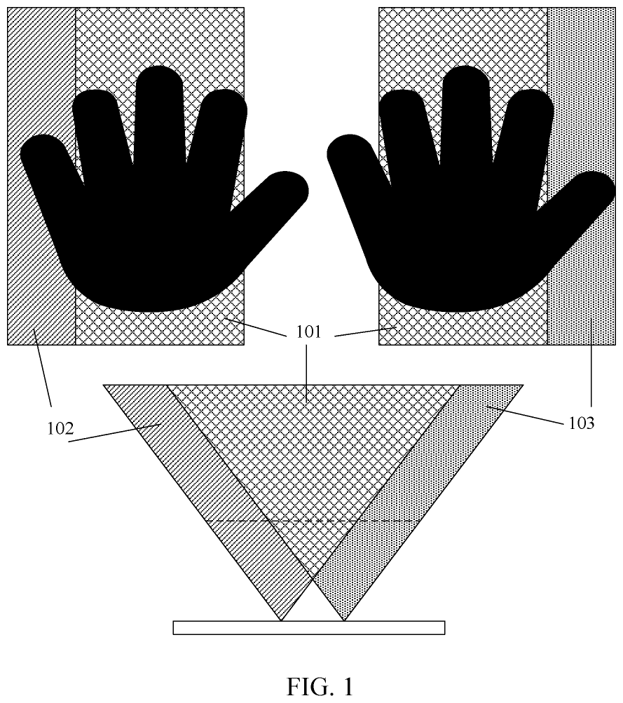

(7) Effective FOV: FOV refers to a maximum range that a lens can capture. FOV is generally expressed in angles, and is divided into a horizontal FOV, a vertical FOV, and a diagonal FOV. In a multi-camera system, the effective FOV refers to an intersecting part of FOVs of a color camera and an infrared camera (region 101 in FIG. 1), i.e., an overlapping part of FOVs of the two cameras, and this region is a common region that can be captured by both cameras. In the field of living body detection, the infrared camera is used for living body detection, while the color camera is used for capturing a color image of a face or palm, and the effective FOV ensures that the two cameras can capture the same region at the same time, thereby realizing accurate living body detection. In comparison and recognition, an image within the effective FOV is used for comparison with a registered image, to ensure recognition accuracy and security. In a multi-modal recognition system, image data within the effective FOV can be fused to improve recognition accuracy and reliability.

(8) Independent FOV: independent FOVs refer to non-intersecting parts of FOVs of the color camera and the infrared camera (region 102 and region 103 in FIG. 1). The independent FOV is exclusive to each camera and cannot be covered by the other camera. In a multi-modal imaging system, the independent FOV can be used to expand an FOV range of the system. For example, in some video detection systems, the color camera and the infrared camera may cover different regions respectively, and a wider video detection range can be achieved by combining the independent FOVs of the color camera and the infrared camera. In some special environments, for example, during night or under low lighting conditions, the independent FOV of the infrared camera can provide an additional detection capability, while the color camera is used for detection under normal lighting conditions.

(9) Black edge: black edges refer to parts, in respective images collected by the color camera and the infrared camera, which have no subject and are filled with black pixels due to spatial alignment. The black edges generally appear at edges of the images, and are caused by incomplete overlapping of FOVs of the two cameras or design of an imaging system. For example, since FOVs of the color camera and the infrared camera may not completely overlap, some regions cannot be captured by the two cameras at the same time, thereby forming black edges in the images. Alternatively, to ensure image quality within the effective FOV, the imaging system may be designed to reserve spaces at edge parts, and the reserved spaces are filled with black pixels to form black edges. Alternatively, in a multi-camera system, to realize spatial alignment of images, cropping or filling may be performed on the images, resulting in black edges.

(10) Spatial alignment: in a multi-camera system, since a color camera and an infrared camera are not at a same point in a horizontal direction, relative positions of a palm in two images are different. Spatial alignment is a process of translating and aligning relative positions of the palm in the two images through translation or other geometric transformations, so as to facilitate further processing and analysis.

Embodiments of the present disclosure provide an image processing method and apparatus, an electronic device, a computer-readable storage medium, and a computer program product, which can be applied to at least the field of cloud technologies or the field of image recognition, and can optimize an effective FOV of an image acquisition device while ensuring an image alignment effect.

An embodiment of the present disclosure provides an image processing method. In the method, effective image cropping is performed by using an unconventional ratio (such as full-size resolution), and during spatial alignment, two images are aligned toward the middle and arc-shaped black edges in original images with distortion are used, to optimize an effective FOV of a camera in a palm-scanning (or palm-recognition) field. Specifically, in the image processing method according to this embodiment of the present disclosure, first, an electronic device obtains an original image pair. The original image pair includes a first original image that is acquired by using a first-type image acquisition device and that includes a target object, and a second original image that is acquired by using a second-type image acquisition device and that includes the target object. Then, image cropping is performed on the first original image to obtain a first cropped image, and image cropping is performed on the second original image to obtain a second cropped image. Then, distortion correction processing is performed on the first cropped image to obtain a first distortion-corrected image, and distortion correction processing is performed on the second cropped image to obtain a second distortion-corrected image. Finally, distortion-aware spatial alignment is performed on the first distortion-corrected image and the second distortion-corrected image to obtain a spatially aligned image including the target object. Distortion-aware spatial alignment is performed on the first distortion-corrected image and the second distortion-corrected image, thereby simultaneously realizing distortion correction and spatial alignment on the first distortion-corrected image and the second distortion-corrected image. In this way, it can be ensured that during image cropping, non-intersecting photographing parts of the first original image and the second original image are not excessively cropped; in other words, an effective FOV of the original image pair is not cropped off. Therefore, the method according to this embodiment of the present disclosure can optimize the effective FOV of the original image pair captured by the first-type image acquisition device and the second-type image acquisition device while ensuring an alignment effect of the original image pair.

Herein, an exemplary application of an image processing device according to an embodiment of the present disclosure is described first. The image processing device is an electronic device configured to implement the image processing method. In an implementation, the image processing device (namely, the electronic device) provided in this embodiment of the present disclosure may be implemented as a terminal, or may be implemented as a server. In an implementation, the image processing device provided in this embodiment of the present disclosure may be implemented as any terminal having an identity information recognition function or an image data processing function, such as a palm scanning/recognition device, a face scanning/recognition device, a notebook computer, a tablet computer, a desktop computer, a mobile phone, a portable music player, a personal digital assistant, a dedicated messaging device, a portable game device, an intelligent robot, an intelligent home appliance, or an intelligent in-vehicle device. In another implementation, the image processing device provided in this embodiment of the present disclosure may alternatively be implemented as a server. The server may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a Content Delivery Network (CDN), and a big data and artificial intelligence platform. The terminal and the server may be connected directly or indirectly through wired or wireless communication. This is not limited in the embodiments of the present disclosure. An exemplary application where the image processing device is implemented as a server is described below.

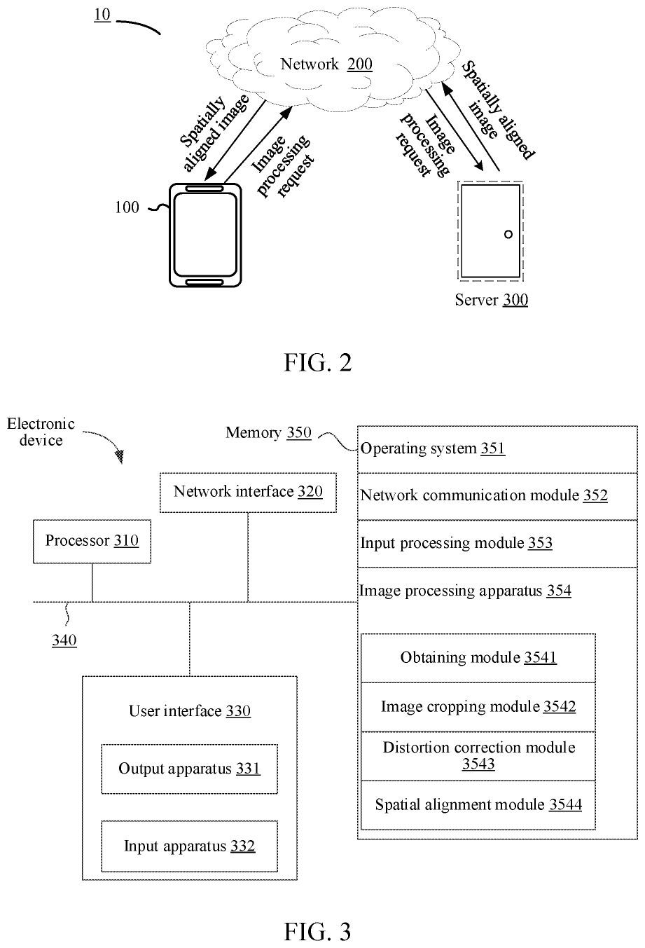

When the image processing device is implemented as a server, the image processing device is included in an image processing system. Referring to FIG. 2, FIG. 2 is an exemplary schematic architectural diagram of an image processing system according to an embodiment of the present disclosure. An image processing system 10 in this embodiment of the present disclosure includes at least a terminal 100, a network 200, and a server 300. The terminal 100 may be a palm scanning device or a face scanning device. The palm scanning device is used as an example for description. A palm scanning application is installed on the palm scanning device, and a palm print of a user collected by the palm scanning device can be recognized by using the palm scanning application, thereby recognizing identity information of the user. In this embodiment of the present disclosure, the server 300 may be a server of the palm scanning application. The server 300 may constitute the image processing device in this embodiment of the present disclosure. In other words, the image processing method in the embodiments of the present disclosure is implemented by using the server 300. The terminal 100 is connected to the server 300 by using the network 200. The network 200 may be a wide area network, a local area network, or a combination thereof.

In this embodiment of the present disclosure, the palm scanning device includes at least a first-type image acquisition device and a second-type image acquisition device. For example, the first-type image acquisition device may be an infrared camera, and the second-type image acquisition device may be a color camera. Referring to FIG. 2, when a user performs palm scanning by using a palm scanning device, the first-type image acquisition device on the palm scanning device captures a first original image including a palm print (namely, a target object) of the user, and the second-type image acquisition device on the palm scanning device captures a second original image including the palm print of the user. Then, the terminal 100 encapsulates the first original image and the second original image into an image processing request, and sends the image processing request to the server 300 through the network 200. Then, in response to the image processing request, the server 300 performs image cropping on the first original image to obtain a first cropped image, and performs image cropping on the second original image to obtain a second cropped image. Next, the server 300 performs distortion correction processing on the first cropped image to obtain a first distortion-corrected image, and performs distortion correction processing on the second cropped image to obtain a second distortion-corrected image. Finally, the server 300 performs distortion-aware spatial alignment on the first distortion-corrected image and the second distortion-corrected image to obtain a spatially aligned image including the palm print of the user. After obtaining the spatially aligned image, the server 300 may return the spatially aligned image to the terminal for display, or may perform identity recognition on the user based on the spatially aligned image, to obtain identity information of the user, so as to perform corresponding service processing based on the identity information. For example, for a palm-scanning clock-in service, a clock-in record of the user is generated after the user performs palm scanning for identity recognition and passes verification; for a palm-scanning payment service, after the user performs palm scanning for identity recognition and passes verification, a payment process of a bound account corresponding to the identity information of the user is executed.

In some embodiments, operations in the image processing method may alternatively be performed by the terminal 100. In other words, the palm scanning device performs spatial alignment on the acquired first original image and second original image. The palm scanning device performs image cropping on the first original image to obtain a first cropped image, and performs image cropping on the second original image to obtain a second cropped image. Then, the palm scanning device performs distortion correction processing on the first cropped image to obtain a first distortion-corrected image, and performs distortion correction processing on the second cropped image to obtain a second distortion-corrected image. Finally, the palm scanning device performs distortion-aware spatial alignment on the first distortion-corrected image and the second distortion-corrected image to obtain a spatially aligned image including the palm print of the user.

The image processing method provided by the embodiments of the present disclosure may alternatively be implemented based on a cloud platform and using a cloud technology. For example, the foregoing server 300 may be a cloud server. The cloud server performs image cropping on the first original image to obtain a first cropped image, and performs image cropping on the second original image to obtain a second cropped image; or the cloud server may perform distortion correction processing on the first cropped image to obtain a first distortion-corrected image, and perform distortion correction processing on the second cropped image to obtain a second distortion-corrected image; or the cloud server may perform distortion-aware spatial alignment on the first distortion-corrected image and the second distortion-corrected image.

In some embodiments, a cloud memory may also be provided. The original image pair may be stored in the cloud memory, or the first cropped image and the second cropped image may be stored in the cloud memory, or the first distortion-corrected image and the second distortion-corrected image may be stored in the cloud memory, or the finally obtained spatially aligned image may be stored in the cloud memory. In this way, during actual service processing, the spatially aligned image may be directly obtained from the cloud memory to implement a corresponding service processing procedure.

The foregoing image processing device (i.e., the electronic device) will be further described below. FIG. 3 is a schematic structural diagram of an electronic device according to an embodiment of the present disclosure. The electronic device shown in FIG. 3 may be an image processing device. The image processing device includes: at least one processor 310, a memory 350, at least one network interface 320, and a user interface 330. Components in the image processing device are coupled together by using a bus system 340. The bus system 340 is configured to implement connection and communication between the components. In addition to a data bus, the bus system 340 further includes a power bus, a control bus, and a status signal bus. However, for clarity of description, all types of buses are marked as the bus system 340 in FIG. 3.

The processor 310 may be an integrated circuit chip having a signal processing capability, such as a general-purpose processor, a digital signal processor (DSP), another programmable logic device, a discrete gate or transistor logic device, or a discrete hardware component. The general-purpose processor may be a microprocessor or any suitable processor. The user interface 330 includes one or more output apparatuses 331 that can display media content, and one or more input apparatuses 332. The memory 350 may be a removable memory, a non-removable memory, or a combination thereof. An exemplary hardware device includes a solid-state memory, a hard disk drive, an optical disk drive, and the like. In some embodiments, the memory 350 includes one or more storage devices physically located away from the processor 310. The memory 350 includes a volatile memory or a non-volatile memory, or may include both a volatile memory and a non-volatile memory. The non-volatile memory may be a read-only memory (ROM). The volatile memory may be a random access memory (RAM). The memory 350 described in this embodiment of the present disclosure is intended to include any suitable type of memory. In some embodiments, the memory 350 can store data to support various operations. Examples of the data include a program, a module, and a data structure, or a subset or a superset thereof, which are described below with examples.

An operating system 351 includes system programs configured to process various basic system services and execute hardware-related tasks, for example, a framework layer, a core library layer, and a driver layer, for implementing various basic services and process hardware-based tasks. A program network communication module 352 is configured to reach another computing device by using one or more (wired or wireless) network interfaces 320, where exemplary network interfaces 320 include: Bluetooth, Wireless Fidelity (WiFi), Universal Serial Bus (USB), and the like. An input processing module 353 is configured to detect one or more user inputs or interactions from one of the one or more input apparatuses 332 and translate the detected input or interaction.

In some embodiments, the apparatus provided in the embodiments of the present disclosure may be implemented in a software manner. FIG. 3 shows an image processing apparatus 354 stored in a memory 350. The image processing apparatus 354 may be an image processing apparatus in an electronic device, may be software in a form of a program, a plug-in, or the like, and includes the following software modules: an obtaining module 3541, an image cropping module 3542, a distortion correction module 3543, and a spatial alignment module 3544. These modules are logical, and therefore may be randomly combined or further split according to implement functions. Functions of the modules are described in the following specification.

In some embodiments, the apparatus provided in the embodiments of the present disclosure may be implemented by using hardware. For example, the apparatus provided in the embodiments of the present disclosure may be a processor in a form of a hardware decoding processor, and is programmed to perform the image processing method provided in the embodiments of the present disclosure. For example, the processor in the form of a hardware decoding processor may use one or more application specific integrated circuits (ASICs), DSPs, programmable logic devices (PLDs), complex programmable logic devices (CPLDs), field-programmable gate arrays (FPGAs), or other electronic components.

The image processing method provided in the embodiments of the present disclosure may be performed by an electronic device. The electronic device may be a server or a terminal. To be specific, the image processing method in the embodiments of the present disclosure may be performed by a server, may be performed by a terminal, or may be performed through interaction between the server and the terminal.

The image processing method provided in the embodiments of the present disclosure may be applied to various service scenarios, for example, the fields such as living body detection, comparison recognition, image fusion, and action cooperation detection. Descriptions are provided below with examples.

In living body detection applications, the image processing method provided in the embodiments of the present disclosure may be used to align positions of a palm or a face in an infrared image and a color image, to ensure spatial consistency between the infrared image and the color image. Then, it is determined whether biological features in front of a lens are from a real living body, rather than means such as a photo, a video or a mask. Key features such as skin texture, blood flow, micro-expression changes may be extracted from the spatially aligned image, and the extracted features are analyzed by using a deep learning model or a suitable image processing method, to determine whether the features are from a real living body. For example, in financial services, living body detection is used to ensure that a user is a real person during account opening, transaction, or identity verification, thereby improving account security.

In comparison and recognition applications, a spatially aligned image may be obtained by using the image processing method provided in the embodiments of the present disclosure. Comparison and recognition are performed on the spatially aligned image to verify an identity of a user: the spatially aligned image is compared with a registered image in a database to determine whether the spatially aligned image and the registered image are from a same person. For example, in an intelligent access control system, a comparison and recognition technology is used to prevent an unauthorized person from entering by using a photo or a fake mask.

In image fusion applications, spatially aligned images may be fused by using methods such as weighted average and maximum fusion, and then features are extracted from the fused image for recognition or classification. For example, in a multi-modal imaging system, an image fusion technology may be used to improve resolution and contrast of an image, thereby improving recognition accuracy.

In action-based liveness detection applications, action-based liveness detection is a living body detection method that verifies whether a user is a real living body by requiring the user to perform a particular action (such as blinking, opening the mouth, or shaking the head) in combination with a face key point positioning technology. For example, in face-scanning unlocking and face-scanning payment on a mobile phone, the action-based liveness detection technology can effectively prevent forgery means such as photos and videos from unlocking the mobile phone or making payment, thereby protecting privacy and property security of a user.

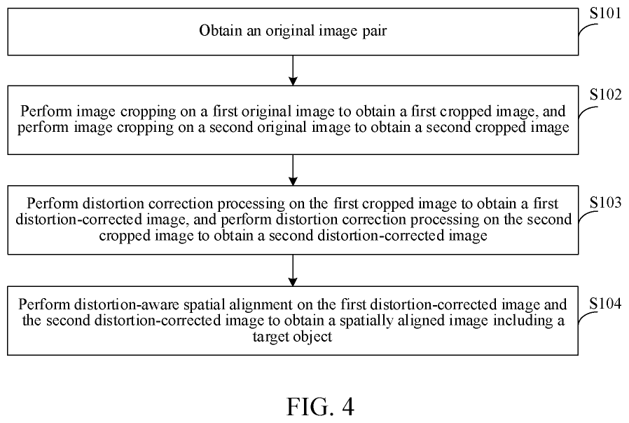

FIG. 4 is an exemplary schematic flowchart of an image processing method according to an embodiment of the present disclosure. Description will be made below with reference to operations shown in FIG. 4. As shown in FIG. 4, the image processing method being executed by a server is taken as an example for description. The method includes the following operation S101 to operation S104:

Operation S101: Obtain an original image pair.

The original image pair includes a first original image that is acquired by using a first-type image acquisition device and that includes a target object, and a second original image that is acquired by using a second-type image acquisition device and that includes the target object.

The first-type image acquisition device and the second-type image acquisition device may be cameras both located on a biological feature capturing device. The first-type image acquisition device is configured to capture the first original image of the target object, and the second-type image acquisition device is configured to capture the second original image of the target object. In other words, the biological feature acquisition device is an acquisition device with dual cameras, and can simultaneously capture two images of the target object. For example, the biological feature acquisition device may be a palm scanning device of an access control system. The first-type image acquisition device may be an infrared camera located on the palm scanning device. The second-type image acquisition device may be a color camera located on the palm scanning device. An infrared image including a palm print of a user is acquired by using the infrared camera, and a color image including the palm print of the user is acquired by using the color camera.

In this embodiment of the present disclosure, since the biological feature acquisition device acquires two images of the target object at the same time, and positions of the target object in the two images may deviate due to factors such as camera design errors and camera parameters, when the two images acquired by the biological feature acquisition device are used for subsequent service processing, to improve service processing accuracy and reduce the position deviation between the two images, spatial alignment needs to be performed on the two images first to obtain a spatially aligned image, and then a subsequent service processing process is performed based on the spatially aligned image.

Operation S102: Perform image cropping on the first original image to obtain a first cropped image, and perform image cropping on the second original image to obtain a second cropped image.

Due to different shooting angles of cameras and different distances between the target object and the cameras, edges of the captured first original image and second original image have blank regions of a specific size. The blank regions are regions that are located around the target object and do not include the target object. The blank regions are regions of white or of other colors in the image, and do not include the target object.

In some embodiments, the blank regions at the edges of the first original image and the second original image may be detected by using any one of the following methods: grayscale and binarization, and contour detection. The grayscale and binarization method is to convert an image into a grayscale image, and then convert the grayscale image into a binary image by using threshold processing. The contour detection method is to detect a contour in an image by using a target function (for example, a findContour function of OpenCV), and find a maximum contour.

In this embodiment of the present disclosure, after the first original image and the second original image are acquired and the blank regions at the edges of the first original image and the second original image are detected, image cropping may be first performed on the first original image and the second original image. The image cropping process may be considered as an effective image cropping process. The effective image cropping refers to cropping an image to retain an effective region related to a specific service in the image and delete an invalid region unrelated to the specific service. For the field of palm scanning, effective image cropping may be performed on the first original image and the second original image by cutting off blank regions in the first original image and the second original image, so as to retain, in middle parts of the first original image and the second original image, regions including the target object as many as possible.

In this embodiment of the present disclosure, a specific cropping ratio may be preset, and then effective image cropping is separately performed on the first original image and the second original image according to the specific cropping ratio, to correspondingly obtain the first cropped image and the second cropped image. In an implementation process, the specific cropping ratio may be an unconventional ratio, where a conventional ratio may be, for example, a 16:9 ratio or a 4:3 ratio. The unconventional ratio is another ratio other than the conventional ratio, for example, a full-size ratio, i.e., a 1:1 ratio.

For example, in this embodiment of the present disclosure, effective image cropping may be separately performed on the first original image and the second original image by using a full-size ratio, to correspondingly obtain the first cropped image and the second cropped image. In this way, all effective information in the first original image and the second original image can be completely reserved, i.e., all information about the target object is retained, thereby retaining all FOVs of the first original image and the second original image.

Operation S103: Perform distortion correction processing on the first cropped image to obtain a first distortion-corrected image, and perform distortion correction processing on the second cropped image to obtain a second distortion-corrected image.

During image processing, distortion refers to image deformation caused by a camera due to technical or physical reasons during photographing. Light enters the camera through a lens. This is a delicate and complex process. When light passes through a lens, loss and refracting occur. Therefore, each optical lens has some distortion. The existence of such distortion may cause image quality degradation, and affect image recognition, analysis, and application. Therefore, distortion correction processing needs to be performed.

Generally, image distortion is mainly classified into two types: radial distortion and tangent distortion. Radial distortion is caused by optical characteristics of a lens, and is mainly manifested as magnification or reduction of a center and edges of an image. The radial distortion includes barrel distortion and pincushion distortion. Tangential distortion is caused by an assembly error between a lens and an imaging plane, and is mainly manifested as distortion of an image in some directions. The tangent distortion is described by the following two parameters: k1 (representing a first parameter of tangent distortion) and k2 (representing a second parameter of tangent distortion).

The objective of the distortion correction processing in this embodiment of the present disclosure is to correct radial distortion. Specifically, distortion types of images in this embodiment of the present disclosure mainly include pincushion distortion and barrel distortion. Edges of an image with pincushion distortion are reduced more than a central portion, causing the image to look like a pincushion. Pincushion distortion generally occurs in a telephoto lens or a telephoto end of a zoom lens, and original straight lines of a target object shrink toward the center, like a pincushion. Edges of an image with barrel distortion are magnified more than a central portion, causing the image to look like a barrel. Barrel distortion is a distortion phenomenon that an imaging picture is expanded into a barrel-like shape due to physical properties of individual lenses and a lens group structure in camera lenses, and generally occurs at a wide-angle end or a wide-angle end of a zoom lens. Straight lines at edges of the picture expand outward to form a barrel shape. Barrel distortion is like pasting paper on a ball, and pincushion distortion is like pressing paper into a bowl.

Distortion correction processing includes at least any one of the following correction methods: a geometry correction method, a correction method using a calibration board, an adaptive filtering-based method, and a convolution kernel-based correction method. The geometrical correction method is a distortion correction method based on internal and external parameters of a camera. The principle of this method is to estimate a transformation matrix required for distortion correction by calculating intrinsic parameters and external parameters of the camera. During implementation, the camera may be calibrated first. Specifically, intrinsic parameters and external parameters of the camera are obtained by photographing a particular calibration object multiple times, and then distortion correction processing is performed by using the intrinsic parameters and the external parameters. The geometric correction method has an advantage of good correction effect and can achieve high precision. The correction method using a calibration board is a simple and effective distortion correction method. The principle of the correction method using a calibration board is to first photograph an image of a calibration board having a known shape, then measure the shape of the calibration board in the image, and finally perform distortion correction by using a measurement result. The correction method using a calibration board has an advantage of simple implementation, only requiring a calibration board with a known shape, and also has high correction precision. The adaptive filtering-based method is a method of performing filtering based on local features of an image. The idea of the adaptive filtering-based method is to determine a distortion degree according to the local features of the image and filter the local features of the image, so as to achieve distortion correction. The adaptive filtering-based method has an advantage of being adaptive to different distortion types and distortion degrees, and can implement distortion correction processing without a calibration object. The convolution kernel-based correction method is a transform matrix-based method. The idea of the convolution kernel-based correction method is to transform an image by using a convolution kernel, thereby implementing distortion correction. A convolution kernel is usually a square matrix, where each element in the matrix corresponds to one coefficient in the transform matrix. The convolution kernel-based correction method has an advantage of simple implementation, only requiring calculation of the convolution kernel and the transformation matrix, and can be adapted to various distortion types and distortion degrees.

Operation S104: Perform distortion-aware spatial alignment on the first distortion-corrected image and the second distortion-corrected image to obtain a spatially aligned image including the target object.

Distortion-aware spatial alignment includes two processing processes: spatial alignment and image cropping. When distortion-aware spatial alignment is performed, spatial alignment and image cropping are simultaneously performed. In other words, spatial alignment and image cropping are performed synchronously. After distortion correction processing is performed on the first cropped image and the second cropped image to correspondingly obtain the first distortion-corrected image and the second distortion-corrected image, the first distortion-corrected image and the second distortion-corrected image are correspondingly deformed images. Therefore, when image cropping is performed on the deformed images, an effective FOV in the first original image and the second original image may be cropped off. If image cropping and spatial alignment of the first distortion-corrected image and the second distortion-corrected image are performed simultaneously, the effective FOV in the first original image and the second original image can be prevented from being cropped off during spatial alignment, so that the spatially aligned image retains a larger amount of effective FOV in the first original image and the second original image.

In the image processing method provided in this embodiment of the present disclosure, when performing spatial alignment on the original image pair, the electronic device sequentially performs effective image cropping and distortion correction processing on the acquired first original image and also sequentially performs effective image cropping and distortion correction processing on the second original image, to obtain the first distortion-corrected image and the second distortion-corrected image on which distortion correction has been performed. Then, distortion-aware spatial alignment is performed on the first distortion-corrected image and the second distortion-corrected image, to obtain the spatially aligned image including the target object. Distortion-aware spatial alignment is performed on the first distortion-corrected image and the second distortion-corrected image, thereby simultaneously realizing distortion correction and spatial alignment on the first distortion-corrected image and the second distortion-corrected image. In this way, it can be ensured that during image cropping, non-intersecting photographing parts of the first original image and the second original image are not excessively cropped; in other words, an effective FOV of the original image pair is not cropped off. Therefore, the method according to this embodiment of the present disclosure can optimize the effective FOV of the original image pair captured by the first-type image acquisition device and the second-type image acquisition device while ensuring an alignment effect of the original image pair.

Hereinafter, the terminal being a palm scanning device is taken as an example to describe application scenarios of the image processing method provided in the embodiments of the present disclosure. The embodiments of the present disclosure may be applied to at least any one of the following exemplary scenarios:

Scenario 1: The palm scanning device may be a device for attendance clock-in. An image processing system includes at least the palm scanning device and a background server of a clock-in system. The palm scanning device may be a device with dual cameras, and has a first-type image acquisition device and a second-type image acquisition device. The first-type image acquisition device is configured to acquire an infrared image, and the second-type image acquisition device is configured to acquire a color image. When a user performs palm-scanning clock-in, the palm scanning device separately acquires an infrared image and a color image that include a palm print of the user, and may perform identity recognition on the user based on the infrared image and the color image.

To ensure accuracy of identity recognition, spatial alignment may be performed on the infrared image and the color image to obtain a spatially aligned image including the palm print of the user after spatial alignment, so as to perform identity recognition on the user by using the spatially aligned image. Spatial alignment may be performed on the infrared image and the color image by using the image processing method provided in the embodiments of the present disclosure.

Scenario 2: The palm scanning device may be a collection device for implementing a palm-scanning payment service. An image processing system includes at least the palm scanning device and a background server of a payment application corresponding to the palm-scanning payment service. For example, the payment application may run on the palm scanning device, and the palm scanning device can further collect a palm print image of a user, so that after identity recognition is performed on the user based on the collected palm print image of the user, a payment account of the user is determined according to an identity recognition result, and deduction is performed on the payment account in the payment application. For another example, the palm scanning device may further be connected to a terminal. The payment application may run on the terminal. The palm scanning device collects the palm print image of the user and transmits the palm print image to the terminal. The terminal transmits the palm print image of the user to the background server of the payment application through the running payment application. After identity recognition is performed on the user by the background server of the payment application, the payment account of the user is determined according to the identity recognition result, and deduction is performed on the payment account in the payment application. The palm scanning device may be a device with dual cameras. The dual cameras include a first-type image acquisition device and a second-type image acquisition device. The first-type image acquisition device is configured to acquire an infrared image, and the second-type image acquisition device is configured to acquire a color image. Specifically, the palm print image captured by the palm scanning device includes an infrared image and a color image.

Similarly, to ensure accuracy of identity recognition, the infrared image and the color image may be spatially aligned, to obtain a spatially aligned image including the palm print of the user after spatial alignment, so as to perform identity recognition on the user by using the spatially aligned image. Spatial alignment may be performed on the infrared image and the color image by using the image processing method provided in the embodiments of the present disclosure.

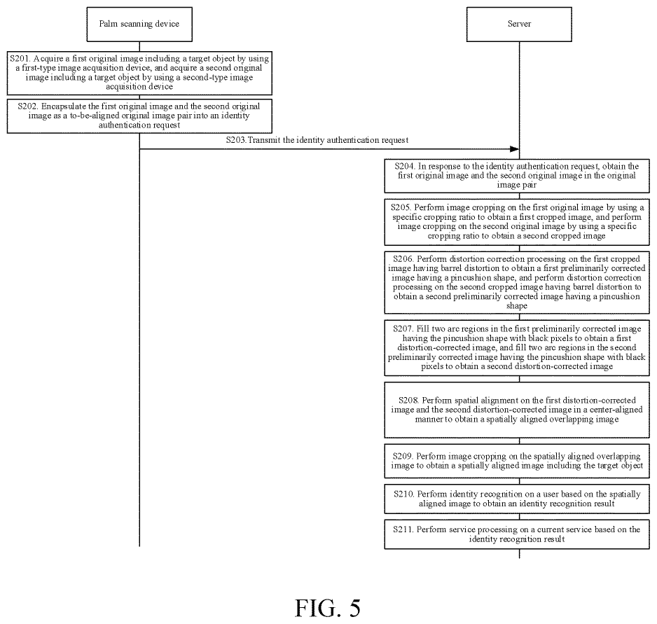

The following describes the image processing method provided in the embodiments of the present disclosure by using the foregoing scenario 1 as an example. FIG. 5 is another exemplary schematic flowchart of an image processing method according to an embodiment of the present disclosure. As shown in FIG. 5, the method includes the following operation S201 to operation S211:

Operation S201: A palm scanning device acquires a first original image including a target object by using a first-type image acquisition device, and acquires a second original image including the target object by using a second-type image acquisition device.

The first original image and the second original image form an original image pair. The first original image and the second original image are acquired by the first-type image acquisition device and the second-type image acquisition device at the same time.

Operation S202: The palm scanning device encapsulates the first original image and the second original image as a to-be-aligned original image pair into an identity authentication request.

When the first original image and the second original image are encapsulated into the identity authentication request as the to-be-aligned original image pair, a request object may be created first, namely, an identity authentication request object is created to store image data and related metadata. Then, image serialization is performed, and the image data of the first original image and the second original image is serialized into a format suitable for transmission, such as Base64 encoding. Finally, the serialized image data is added to the identity authentication request object, and other necessary metadata may be added, for example, information such as a timestamp and a device ID of the palm scanning device.

Operation S203: The palm scanning device transmits the identity authentication request to a server.

The palm scanning device may have a network module, and may transmit the identity authentication request to the server by using the network module. In some embodiments, the palm scanning device may further be connected to a terminal, and an application program of a particular service (for example, an identity authentication service) runs on the terminal. After acquiring the first original image and the second original image, the palm scanning device may transmit the first original image and the second original image to the terminal. The terminal encapsulates, by running the application program, the first original image and the second original image as the to-be-aligned original image pair into the identity authentication request, and the terminal transmits the identity authentication request to the server. In some embodiments, the terminal may transmit the identity authentication request by using a protocol such as Hypertext Transfer Protocol (HTTP) or Web Socket.

Operation S204: The server obtains, in response to the identity authentication request, the first original image and the second original image in the original image pair.

In this embodiment of the present disclosure, the first original image and the second original image may be images having barrel distortion. Barrel distortion is a distortion phenomenon that an imaging picture is expanded into a barrel-like shape due to physical properties of individual lenses and a lens group structure in camera lenses, and straight lines at edges of the picture with barrel distortion expand outward to form a barrel shape.

Operation S205: The server performs image cropping on the first original image by using a specific cropping ratio to obtain a first cropped image, and performs image cropping on the second original image by using a specific cropping ratio to obtain a second cropped image.

The cropping ratio refers to a size ratio of a cropped image to an original image. For example, if the cropping ratio is 0.8, it indicates that a width and a height of a cropped image are 80% of those of the original image respectively. Cropping the first cropped image from the first original image according to the specific cropping ratio may be cropping a target region from the first original image. A cropping method may be center cropping, edge cropping, or cropping based on a particular region.

In some embodiments, the specific cropping ratio may be an unconventional ratio. Separately performing effective image cropping on the first original image and the second original image by using the specific cropping ratio may be implemented in the following manner: performing full-size effective image cropping on the first original image by using the unconventional ratio to obtain the first cropped image, and performing full-size effective image cropping on the second original image by using the unconventional ratio to obtain the second cropped image.

In this embodiment of the present disclosure, since the full-size effective image cropping is performed separately on the first original image and the second original image by using the unconventional ratio, and the first original image and the second original image are images having barrel distortion, the first cropped image and the second cropped image that are obtained after the effective image cropping are also images having barrel distortion. In addition, performing image cropping on the first original image and the second original image by using the specific cropping ratio can effectively remove blank regions in the images and retain core parts of the target object. This method is widely applied to an image preprocessing stage in the palm scanning device, helping improve image quality and processing efficiency. By properly selecting the cropping ratio, it can be ensured that the cropped images meet requirements of actual applications.

Operation S206: The server performs distortion correction processing on the first cropped image having barrel distortion to obtain a first preliminarily corrected image having a pincushion shape, and performs distortion correction processing on the second cropped image having barrel distortion to obtain a second preliminarily corrected image having a pincushion shape.

In this embodiment of the present disclosure, distortion correction processing may be separately performed on the first cropped image and the second cropped image having barrel distortion by using any correction method. The correction method includes: a geometry correction method, a correction method using a calibration board, an adaptive filtering-based method, and a convolution kernel-based correction method.

After distortion correction processing is separately performed on the first cropped image and the second cropped image having barrel distortion, the formed first preliminarily corrected image and second preliminarily corrected image have pincushion shapes. To be specific, left and right edges of the first preliminarily corrected image and the second preliminarily corrected image will shrink toward the center like a pincushion.

Operation S207: The server fills two arc-shaped regions in the first preliminarily corrected image having the pincushion shape with black pixels to obtain a first distortion-corrected image, and fills two arc-shaped regions in the second preliminarily corrected image having the pincushion shape with black pixels to obtain a second distortion-corrected image.

The first distortion-corrected image includes two arc-shaped black edge regions formed after the distortion correction processing is performed on the first cropped image having barrel distortion, and the second distortion-corrected image includes two arc-shaped black edge regions formed after the distortion correction processing is performed on the second cropped image having barrel distortion. The two arc-shaped regions refer to inward concave regions respectively possessed by the formed first preliminarily corrected image and second preliminarily corrected image having the pincushion shape. In other words, in palm-scanning recognition, after the distortion correction processing is performed on the first cropped image to obtain the first preliminarily corrected image, and the distortion correction processing is performed on the second cropped image to obtain the second preliminarily corrected image, it is usually necessary to fill blank regions generated due to the distortion correction. These blank regions are generally arc-shaped and located at edges of the first preliminarily corrected image and the second preliminarily corrected image.

During filling of the arc-shaped regions, the two concave regions may be filled with black pixels, and the arc-shaped regions filled with the black pixels are the arc-shaped black edge regions described above.

This embodiment of the present disclosure is described by using an example that in the distortion correction processing, only left and right edges of the first cropped image and the second cropped image having barrel distortion are subjected to inward distortion correction. In this case, left and right symmetrical arc-shaped regions are formed, and after the arc-shaped regions are filled with black pixels, two arc-shaped black edge regions are formed. Certainly, in other embodiments, in the distortion correction processing, inward distortion correction may be performed on the upper, lower, left, and right edges of the first cropped image and the second cropped image having barrel distortion. In this way, an upper arc-shaped region and a lower arc-shaped region symmetrical to each other, and a left arc-shaped region and a right arc-shaped region symmetrical to each other are formed, namely, a total of four arc-shaped regions are formed. After the four arc-shaped regions are filled with black pixels, four arc-shaped black edge regions are formed.

Operation S208: The server performs spatial alignment on the first distortion-corrected image and the second distortion-corrected image in a center-aligned manner to obtain a spatially aligned overlapping image.

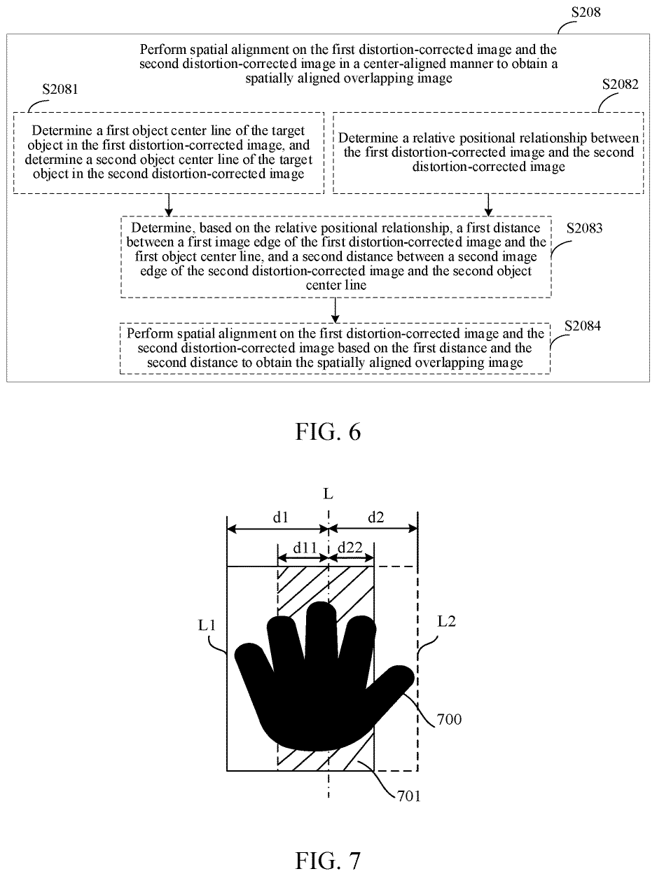

In some embodiments, referring to FIG. 6, FIG. 6 shows a process of performing spatial alignment on the first distortion-corrected image and the second distortion-corrected image in a center-aligned manner in operation S208, which may be implemented by using the following operation S2081 to operation S2084:

Operation S2081: Determine a first object center line of the target object in the first distortion-corrected image, and determine a second object center line of the target object in the second distortion-corrected image.

The first object center line of the target object in the first distortion-corrected image having the arc-shaped black edge regions and the second object center line of the target object in the second distortion-corrected image having the arc-shaped black edge regions may be determined separately. The first object center line is a line passing through a center point of the target object in the first distortion-corrected image and parallel to left and right edges of the first distortion-corrected image having the arc-shaped black edge region. The second object center line is a line passing through a center point of the target object in the second distortion-corrected image and parallel to left and right edges of the second distortion-corrected image having the arc-shaped black edge regions.

Operation S2082: Determine a relative positional relationship between the first distortion-corrected image and the second distortion-corrected image.

The relative positional relationship between the first distortion-corrected image having the arc-shaped black edge regions and the second distortion-corrected image having the arc-shaped black edge regions may be determined. The relative positional relationship refers to a left-right relative relationship between the first distortion-corrected image having the arc-shaped black edge regions and the second distortion-corrected image having the arc-shaped black edge regions. To be specific, it is determined which one of the first distortion-corrected image having arc-shaped black edge regions and the second distortion-corrected image having arc-shaped black edge regions is located on a left side and which one is located on a right side.

Operation S2083: Determine, based on the relative positional relationship, a first distance between a first image edge of the first distortion-corrected image and the first object center line and a second distance between a second image edge of the second distortion-corrected image and the second object center line.

The first image edge is an edge determined based on the relative positional relationship to be away from the second distortion-corrected image, and the second image edge is an edge determined based on the relative positional relationship to be away from the first distortion-corrected image.

Operation S2084: Perform spatial alignment on the first distortion-corrected image and the second distortion-corrected image based on the first distance and the second distance to obtain the spatially aligned overlapping image.

Spatial alignment may be performed on the first distortion-corrected image having the arc-shaped black edge regions and the second distortion-corrected image having the arc-shaped black edge regions, to obtain the spatially aligned overlapping image. During implementation, a first movement direction and a first movement distance of the first distortion-corrected image having the arc-shaped black edge regions may be calculated based on the first distance and the second distance, and a second movement direction and a second movement distance of the second distortion-corrected image having the arc-shaped black edge regions may be calculated based on the first distance and the second distance. Then, the first distortion-corrected image having the arc-shaped black edge regions is moved based on the first movement direction and the first movement distance, and the second distortion-corrected image having the arc-shaped black edge regions is moved based on the second movement direction and the second movement distance, to implement spatial alignment on the first distortion-corrected image having the arc-shaped black edge regions and the second distortion-corrected image having the arc-shaped black edge regions and obtain the spatially aligned overlapping image. The spatially aligned overlapping image is an image of an overlapping region of the two images after the first distortion-corrected image having the arc-shaped black edge regions and the second distortion-corrected image having the arc-shaped black edge regions are moved. The image of the overlapping region forms the spatially aligned image.

In this embodiment of the present disclosure, performing spatial alignment on the first distortion-corrected image having the arc-shaped black edge regions and the second distortion-corrected image having the arc-shaped black edge regions based on the first distance and the second distance may be implemented in the following manner: first, determining a first alignment direction (i.e., the first movement direction) of the first distortion-corrected image having the arc-shaped black edge regions and a second alignment direction (i.e., the second movement direction) of the second distortion-corrected image having the arc-shaped black edge regions based on the relative positional relationship, where the first alignment direction is opposite to the second alignment direction; then, determining the first movement distance of the first distortion-corrected image having the arc-shaped black edge regions based on the first distance and the second distance, and determining the second movement distance of the second distortion-corrected image having the arc-shaped black edge regions based on the first distance and the second distance; finally, moving the first distortion-corrected image having the arc-shaped black edge regions along the first alignment direction based on the first movement distance, and moving the second distortion-corrected image having the arc-shaped black edge regions along the second alignment direction based on the second movement distance to obtain the spatially aligned overlapping image. In other words, after the first distance and the second distance are determined, the first movement distance of the first distortion-corrected image having the arc-shaped black edge regions and the second movement distance of the second distortion-corrected image having the arc-shaped black edge regions further need to be calculated based on the first distance and the second distance. Then, the spatial alignment process is implemented by using the first movement distance and the second movement distance.

FIG. 7 is a schematic diagram of an implementation principle of performing image processing in a center-aligned manner according to an embodiment of the present disclosure. During spatial alignment, movement alignment is performed on the two images (i.e., the first distortion-corrected image and the second distortion-corrected image) in a left-right direction. The target object is a palm 700 in FIG. 7, a solid line box corresponds to the first distortion-corrected image having the arc-shaped black edge regions, a dashed line box corresponds to the second distortion-corrected image having the arc-shaped black edge regions, and the arc-shaped black edge regions filled with black pixels are not shown in FIG. 7. It is assumed that widths of the two images are the same and are known, and are both D. FIG. 7 shows a result after spatial alignment. Therefore, the first object center line and the second object center line overlap in FIG. 7, denoted as a first object center line L (including the overlapped second object center line). The relative positional relationship between the first distortion-corrected image having the arc-shaped black edge regions and the second distortion-corrected image having the arc-shaped black edge regions is as follows: the first distortion-corrected image having the arc-shaped black edge regions is located on the left of the second distortion-corrected image having the arc-shaped black edge regions. Therefore, during spatial alignment, the first distortion-corrected image having the arc-shaped black edge regions is moved rightwards and the second distortion-corrected image having the arc-shaped black edge regions is moved leftwards. In addition, based on the relative positional relationship, it may be determined that the first image edge of the first distortion-corrected image having the arc-shaped black edge regions is L1, and the second image edge of the second distortion-corrected image having the arc-shaped black edge regions is L2. In this way, a first distance d1 between the first image edge L1 of the first distortion-corrected image having the arc-shaped black edge regions and the first object center line L, and a second distance d2 between the second image edge L2 of the second distortion-corrected image having the arc-shaped black edge regions and the second object center line L may be calculated.

After the first distance d1 and the second distance d2 are obtained, subsequently, spatial alignment is performed on the first distortion-corrected image having the arc-shaped black edge regions and the second distortion-corrected image having the arc-shaped black edge regions based on the first distance d1 and the second distance d2. During spatial alignment, it may be first calculated that a length of d22 in FIG. 7 is equal to D−d1, and a length of d11 in FIG. 7 is equal to D−d2. After d11 and d22 are calculated, the first movement distance by which the first distortion-corrected image having the arc-shaped black edge regions moves to the right may be further calculated as d1−d11, and the second movement distance by which the second distortion-corrected image having the arc-shaped black edge regions moves to the left may be calculated as d2−d22. In this way, spatial alignment may be separately performed on the first distortion-corrected image having the arc-shaped black edge regions and the second distortion-corrected image having the arc-shaped black edge regions based on the first movement distance d1−d11 and the second movement distance d2−d22 that are obtained through calculation, to obtain a final spatially aligned overlapping image, i.e., a hatched region 701 in FIG. 7.

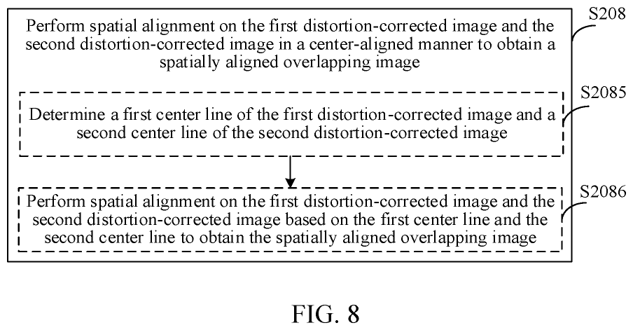

In some other embodiments, referring to FIG. 8, FIG. 8 shows a process of performing spatial alignment on the first distortion-corrected image and the second distortion-corrected image in a center-aligned manner in operation S208, which may further be implemented through the following operation S2085 to operation S2086:

Operation S2085: Determine a first center line of the first distortion-corrected image and a second center line of the second distortion-corrected image.

Since a palm is usually located at a middle position of an image during palm scanning (even if not completely in the middle, a deviation distance to two sides is not excessively large), spatial alignment is performed by using the first center line of the first distortion-corrected image having the arc-shaped black edge regions and the second center line of the second distortion-corrected image having the arc-shaped black edge regions as alignment targets.

The first center line is a central axis of the entire first distortion-corrected image having the arc-shaped black edge regions, and the first center line is parallel to left and right edges of the first distortion-corrected image having the arc-shaped black edge regions. The second center line is a central axis of the entire second distortion-corrected image having the arc-shaped black edge regions, and the second center line is parallel to left and right edges of the second distortion-corrected image having the arc-shaped black edge regions.

Operation S2086: Perform spatial alignment on the first distortion-corrected image and the second distortion-corrected image based on the first center line and the second center line to obtain the spatially aligned overlapping image.

The operation of performing spatial alignment on the first distortion-corrected image having the arc-shaped black edge regions and the second distortion-corrected image having the arc-shaped black edge regions based on the first center line and the second center line may be implemented in the following manner: taking any one of the first center line and the second center line as a target center line, and performing spatial alignment on the first distortion-corrected image and the second distortion-corrected image by taking the target center line as a center line of a final aligned overlapping image. Alternatively, a parallel line between the first center line and the second center line may be taken as the target center line. For example, a vertical distance between the first center line and the second center line may be determined, and half of the vertical distance is used as a center line moving value; then the first center line is moved toward the second center line according to the center line moving value, or the second center line is moved toward the first center line according to the center line moving value, and a line segment where a movement end position is located is used as the target center line. After the target center line is determined, spatial alignment may be performed on the first distortion-corrected image and the second distortion-corrected image by taking the target center line as the center line of the final aligned overlapping image.

During spatial alignment, the first distortion-corrected image and the second distortion-corrected image may be moved left and right respectively until the first center line of the first distortion-corrected image and the second center line of the second distortion-corrected image both overlap with the target center line, so as to obtain a final spatially aligned overlapping image, referring to a hatched region 701 in FIG. 7.

Operation S209: The server performs image cropping on the spatially aligned overlapping image to obtain a spatially aligned image including the target object.

The image cropping may be cropping the spatially aligned overlapping image to obtain the spatially aligned image including the target object. As shown in FIG. 7, regions other than the hatched region 701 may be cropped off, only the hatched region 701 is retained, and an image formed by the hatched region 701 is used as the spatially aligned image including the target object.

Operation S210: The server performs identity recognition on a user based on the spatially aligned image to obtain an identity recognition result.

In this embodiment of the present disclosure, identity recognition may be performed by using a pre-trained identity recognition model. For the identity recognition model, a sample image may be first obtained, and the sample image is preprocessed. For example, preprocessing operations include: grayscale processing (converting the sample image into a grayscale image), denoising (removing noise in the sample image by using a method such as Gaussian blur), and binarization (converting the sample image into a binary image to facilitate subsequent processing). Then, feature extraction is performed on the preprocessed sample image, and features of the target object are extracted from the preprocessed sample image. Texture features may be extracted by using a Gabor filter, or key points and descriptors in the preprocessed sample image may be extracted by using an Oriented FAST and Rotated BRIEF (ORB) feature extraction algorithm. After the features are extracted, a machine learning model such as a Support Vector Machine (SVM) or a deep learning model (such as VGG16), may be trained by using the extracted features, to obtain the identity recognition model. Subsequently, identity recognition is performed on the spatially aligned image by using the trained identity recognition model.

Operation S211: The server performs service processing on a current service based on the identity recognition result.

The server performs service processing on the current service based on the identity identification result, and service processing of various services may be performed. Descriptions are provided below with examples:

In a financial service, a palm image of a user is collected by using a palm scanning device, and palm features of the user are recognized and compared by using a palm scanning recognition technology. If authentication succeeds, a system grants payment authorization to the user, and allows the user to perform a payment operation. In a bank or financial institution, palm-scanning recognition may be used for login and operation of a user account, ensuring security of the account and convenience of operation.

In an access control and security service, for example, in a place such as an enterprise, a school, or a community, a palm-scanning recognition technology may be applied to an access control system, to implement identity authentication and recording of persons coming in and out, thereby improving a security management level. For another example, by using a palm-scanning recognition technology, face information can be detected and compared in real time, to quickly find a suspicious person, thereby improving security.

In an intelligent transportation service, for example, in public transportation scenarios such as subways and buses, palm-scanning recognition may be used to quickly verify passenger identities, implementing contactless payment and passage, improving passage efficiency. For another example, in airport security check and railway ticket check, palm-scanning recognition may be used to quickly verify passenger identities, thereby reducing queuing time and improving travel efficiency.

In a medical and health service, for example, in hospital registration and visit registration, palm-scanning recognition may be used to quickly collect patient identity information, reducing queuing waiting time and improving medical service efficiency. For another example, in medical insurance reimbursement and settlement processes, palm-scanning recognition may be used to quickly verify patient identities, ensuring safe use of medical insurance funds.

In services in the field of education, for example, in school admission registration and student status management processes, palm-scanning recognition may be used to quickly collect and manage identity information of students, thereby improving information collection efficiency and accuracy. For another example, in various examination registration processes, palm-scanning recognition may be used to quickly verify examinee identities.

In an intelligent retail service, for example, in an unmanned retail scenario, palm-scanning recognition may be used to quickly verify customer identities, implementing contactless shopping and payment, thereby improving shopping experience. For another example, in retail enterprises, palm-scanning recognition may be used for member identity authentication and management, to provide personalized services.

In a government service, for example, in a government online service platform, palm-scanning recognition may be used for citizens to handle services such as household registration, passport application, and social security inquiry online, ensuring that identities of citizens handling government services are real and valid.

In an intelligent office service, for example, in enterprise attendance management, palm-scanning recognition may be used to quickly verify employee identities, implementing automatic attendance checking and improving management efficiency. For another example, in a conference room reservation system, palm-scanning recognition may be used to quickly verify user identities, thereby implementing automatic reservation and use of conference rooms.

According to the image processing method provided in the embodiments of the present disclosure, for the first original image and the second original image having barrel distortion, image cropping and spatial alignment are simultaneously performed. Therefore, it can be ensured that during image cropping, non-intersecting photographing parts of the first original image and the second original image are not excessively cropped. In other words, an effective FOV of the original image pair is not cropped off. Therefore, the method according to the embodiments of the present disclosure can optimize the effective FOV of the original images acquired by two image acquisition devices, i.e., the first-type image acquisition device and the second-type image acquisition device, in the field of identity recognition while ensuring an alignment effect of the original image pair.

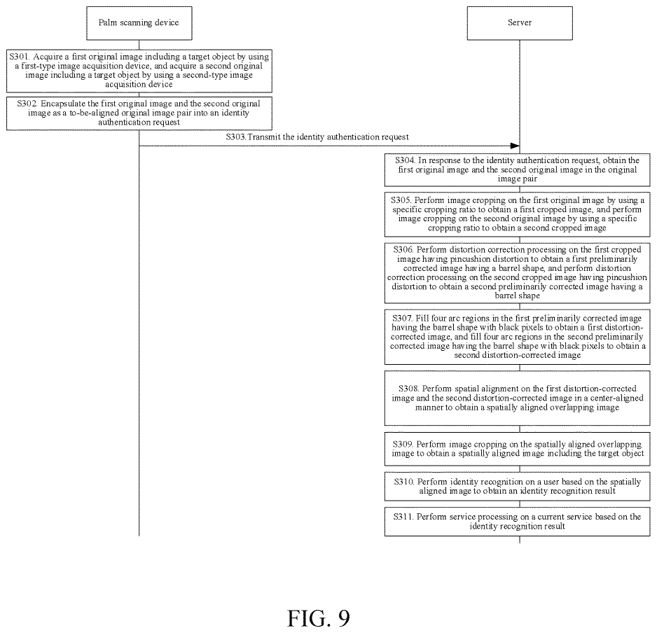

In some embodiments, the first original image and the second original image may alternatively be images having pincushion distortion. The image processing method provided in the embodiments of the present disclosure will be described below by taking the first original image and the second original image that have pincushion distortion as an example. As shown in FIG. 9, the method includes the following operation S301 to operation S311.

An implementation process of operation S301 to operation S311 is the same as that of operation S201 to operation S211, and a difference lies only in that operation S301 to operation S311 involve performing spatial alignment processing on the first original image and the second original image that have pincushion distortion, while operation S201 to operation S211 involve performing spatial alignment processing on the first original image and the second original image that have barrel distortion. Therefore, in this embodiment of the present disclosure, repeated operations are not described in detail, and for specific explanations, refer to explanations of corresponding operations in operation S201 to operation S211.

Operation S301: A palm scanning device acquires a first original image including a target object by using a first-type image acquisition device, and acquires a second original image including a target object by using a second-type image acquisition device.

Operation S302: The palm scanning device encapsulates the first original image and the second original image as a to-be-aligned original image pair into an identity authentication request.

Operation S303: The palm scanning device transmits the identity authentication request to a server.

Operation S304: The server obtains, in response to the identity authentication request, the first original image and the second original image in the original image pair.

Operation S305: The server performs image cropping on the first original image by using a specific cropping ratio to obtain a first cropped image, and performs image cropping on the second original image by using a specific cropping ratio to obtain a second cropped image.

The first original image and the second original image are images having pincushion distortion; correspondingly, the first cropped image and the second cropped image are also images having pincushion distortion. The pincushion distortion means that original straight lines of the target object contract towards the center, like a pincushion.

Operation S306: The server performs distortion correction processing on the first cropped image having pincushion distortion to obtain a first preliminarily corrected image having a barrel shape, and performs distortion correction processing on the second cropped image having pincushion distortion to obtain a second preliminarily corrected image having a barrel shape.

In this embodiment of the present disclosure, distortion correction processing may be separately performed on the first cropped image and the second cropped image that have pincushion distortion by using any correction method. The correction method includes: a geometry correction method, a correction method using a calibration board, an adaptive filtering-based method, and a convolution kernel-based correction method.

After distortion correction processing is separately performed on the first cropped image and the second cropped image having pincushion distortion, the formed first preliminarily corrected image and second preliminarily corrected image have barrel shapes. To be specific, left and right edges of the first preliminarily corrected image and the second preliminarily corrected image expand outward, like a barrel.

Operation S307: The server fills four arc-shaped regions in the first preliminarily corrected image having the barrel shape with black pixels to obtain a first distortion-corrected image, and fills four arc-shaped regions in the second preliminarily corrected image having the barrel shape with black pixels to obtain a second distortion-corrected image.

The first distortion-corrected image includes four arc-shaped black edge regions formed after the distortion correction processing is performed on the first cropped image having pincushion distortion, and the second distortion-corrected image includes four arc-shaped black edge regions formed after the distortion correction processing is performed on the second cropped image having pincushion distortion. The four arc-shaped regions refer to arc-shaped regions at four corners of a barrel-shaped image formed after the distortion correction processing is separately performed on the first cropped image or the second cropped image having pincushion distortion. Specifically, after the distortion correction processing is separately performed on the first cropped image or the second cropped image having pincushion distortion to form an image having a barrel shape, the image having the barrel shape may be circumscribed by a rectangle. In this case, there are four arc-shaped regions that are located outside the barrel-shaped image and inside the circumscribed rectangle. In other words, in palm-scanning recognition, after distortion correction processing is performed on the first cropped image to obtain the first preliminarily corrected image, and distortion correction processing is performed on the second cropped image to obtain the second preliminarily corrected image, it is usually necessary to fill blank regions at four corners generated due to distortion correction. These blank regions are generally arc-shaped and located at four corners of the first preliminarily corrected image and the second preliminarily corrected image.

During filling of the arc-shaped regions, the four arc-shaped regions may be filled with black pixels, and the arc-shaped regions filled with the black pixels are the arc-shaped black edge regions described above.

This embodiment of the present disclosure is described by using an example that in the distortion correction processing, only left and right edges of the first cropped image and the second cropped image having pincushion distortion are subjected to outward distortion correction. In this case, two pairs of arc-shaped regions symmetrical in a left-right direction are formed (i.e., four arc-shaped regions), and after the two pairs of arc-shaped regions are filled with black pixels, four arc-shaped black edge regions are formed. Certainly, in other embodiments, in the distortion correction processing, outward distortion correction may be performed on the upper, lower, left, and right edges of the first cropped image and the second cropped image having pincushion distortion. In this way, two pairs of arc-shaped regions symmetrical in an upper-lower direction, and two pairs of arc-shaped regions symmetrical in the left-right direction are formed, namely, a total of four pairs of arc-shaped regions, i.e., eight arc-shaped regions, are formed. After the eight arc-shaped regions are filled with black pixels, eight arc-shaped black edge regions are formed.

Operation S308: The server performs spatial alignment on the first distortion-corrected image and the second distortion-corrected image in a center-aligned manner to obtain a spatially aligned overlapping image.

The implementation process of performing spatial alignment on the first distortion-corrected image and the second distortion-corrected image in operation S308 is the same as the implementation process in operation S208, and details are not described in this embodiment of the present disclosure again.

Operation S309: The server performs image cropping on the spatially aligned overlapping image to obtain a spatially aligned image including the target object.

Operation S310: The server performs identity recognition on a user based on the spatially aligned image to obtain an identity recognition result.

Operation S311: The server performs service processing on a current service based on the identity recognition result.

According to the image processing method provided in the embodiments of the present disclosure, for the first original image and the second original image having pincushion distortion, distorted image cropping and spatial alignment are simultaneously performed. Therefore, it can be ensured that during distorted image cropping, non-intersecting photographing parts of the first original image and the second original image are not excessively cropped. In other words, an effective FOV of the original image pair is not cropped off. Therefore, the method according to the embodiments of the present disclosure can optimize the effective FOV of the original images acquired by two image acquisition devices, i.e., the first-type image acquisition device and the second-type image acquisition device, in the field of identity recognition while ensuring an alignment effect of the original image pair.

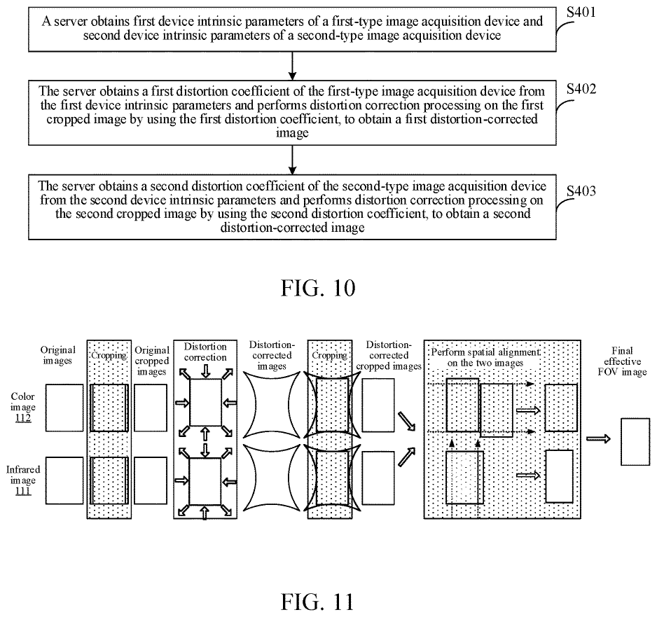

Based on the foregoing embodiment, an embodiment of the present disclosure further provides an implementation method of distortion correction processing, where processes of separately performing distortion correction processing on the first cropped image having barrel distortion and the second cropped image having barrel distortion, or separately performing distortion correction processing on the first cropped image having pincushion distortion and the second cropped image having pincushion distortion may both be implemented by using the implementation method provided in this embodiment of the present disclosure. FIG. 10 is a schematic flowchart of an implementation method of distortion correction processing according to an embodiment of the present disclosure. As shown in FIG. 10, the method includes the following operation S401 to operation S403:

Operation S401: A server obtains first device intrinsic parameters of a first-type image acquisition device and second device intrinsic parameters of a second-type image acquisition device.

In some embodiments, the operation of obtaining, by the server, first device intrinsic parameters of a first-type image acquisition device and second device intrinsic parameters of a second-type image acquisition device may be implemented in the following manner: First, the server obtains preset camera calibration standard values. Then, the first-type image acquisition device is independently calibrated based on the camera calibration standard values by using a preset calibration tool to obtain the first device intrinsic parameters of the first-type image acquisition device, and the second-type image acquisition device is independently calibrated based on the camera calibration standard values to obtain the second device intrinsic parameters of the second-type image acquisition device.

The camera calibration standard values are preset values. The preset camera calibration standard values generally include parameters of a calibration board, such as the number of corner points and actual physical sizes of squares of a checkerboard, which are used for a subsequent calibration process. The calibration tool is generally a calibration board with a checkerboard pattern. Corner points of the checkerboard are used as feature points for calculating intrinsic parameters of the camera in the calibration process.

When the first-type image acquisition device (or the second-type image acquisition device) is independently calibrated based on the camera calibration standard values, calibration images may be first acquired. Images of the calibration board are acquired by the first-type image acquisition device (or the second-type image acquisition device) from different angles and distances to ensure that the calibration board covers the entire field of view of the camera, and sufficient data are obtained by photographing from multiple angles. Then, processing is performed on the acquired images to extract corner point information of the checkerboard. For example, corner points of the checkerboard may be automatically detected using a findChessboardCorners function provided by OpenCV. After that, a calibrateCamera function of OpenCV is used to calculate the first device intrinsic parameters (i.e., intrinsic parameters of the first-type image acquisition device, or the second device intrinsic parameters) according to the extracted corner point information and an actual size of the calibration board, where the intrinsic parameters include a focal length, principal point coordinates, and distortion coefficients.

In this embodiment of the present disclosure, the first-type image acquisition device may be an infrared camera, and the second-type image acquisition device may be a color camera. Correspondingly, the first original image is an infrared image, and the second original image is a color image.

Operation S402: The server obtains a first distortion coefficient of the first-type image acquisition device from the first device intrinsic parameters and performs distortion correction processing on the first cropped image by using the first distortion coefficient, to obtain a first distortion-corrected image.

The first distortion coefficient is a coefficient by which an image changes when the first-type image acquisition device acquires the image. During distortion correction processing, a distortion correction coefficient of the first-type image acquisition device may be determined according to the first distortion coefficient. A value of the distortion correction coefficient is the same as that of the first distortion coefficient, and a sign of the distortion correction coefficient is opposite to that of the first distortion coefficient. For example, if the first distortion correction coefficient is +0.5 (indicating that the image acquired by the first-type image acquisition device is distorted toward a square by 0.5 times), the corresponding distortion correction coefficient is −0.5 (indicating that during distortion correction processing, distortion correction needs to be performed in a negative direction by 0.5 times).

Operation S403. The server obtains a second distortion coefficient of the second-type image acquisition device from the second device intrinsic parameters and performs distortion correction processing on the second cropped image by using the second distortion coefficient, to obtain a second distortion-corrected image.

The second distortion coefficient is a coefficient by which an image changes when the second-type image acquisition device acquires the image. During distortion correction processing, a distortion correction coefficient of the second-type image acquisition device may be determined according to the second distortion coefficient. A value of the distortion correction coefficient is the same as that of the second distortion coefficient, and a sign of the distortion correction coefficient is opposite to that of the second distortion coefficient.

In this embodiment of the present disclosure, based on preset camera calibration standard values, the first-type image acquisition device and the second-type image acquisition device are separately calibrated by using a calibration tool, to obtain device intrinsic parameters of the first-type image acquisition device and the second-type image acquisition device. These device intrinsic parameters may be used for subsequent image distortion correction and identity recognition, to ensure image quality and recognition accuracy.

An exemplary application of the embodiments of the present disclosure in an actual application scenario is described below.

In a face scanning scenario, spatial alignment is performed on three images including a color image, an infrared image, and a depth image in related technologies, while a palm scanning scenario does not care about a horizontal effective FOV but pays more attention to a vertical effective FOV. In the palm-scanning scenario, a color image and an infrared image are aligned according to a fixed position. Disadvantages of the fixed position alignment are: on one hand, a spatial alignment effect is poor, and palm alignment is only achieved at a selected calibrated position (for example, when the selected calibrated position is at 8 centimeters (cm), palm alignment is only achieved at 8 cm); on the other hand, the horizontal effective FOV is small, resulting in a small usable distance range for palm scanning and poor user experience in palm scanning. Alternatively, in the field of palm scanning, two images are dynamically aligned based on a depth distance of a PSensor. Although such a method can achieve dynamic palm alignment (alignment can be achieved within 5 cm to 12 cm of palm scanning), the horizontal effective FOV is small, resulting in a small usable distance range for palm scanning and poor user experience in palm scanning.

Based on at least one of the foregoing problems existing in the related technologies, an embodiment of the present disclosure provides an image processing method, which optimizes a horizontal effective FOV of a camera in the field of palm scanning by using effective image cropping with full-size resolution, aligning two images toward the center during spatial alignment, and using arc-shaped black edges in an original image with barrel distortion.

FIG. 11 is a schematic flowchart of obtaining an effective FOV in a palm scanning field according to an embodiment of the present disclosure. The procedure of obtaining an effective FOV is an image processing method. For an infrared image 111 and a color image 112 (corresponding to the first original image and the second original image) in original images, effective image cropping is sequentially performed on the original images, to obtain original cropped images (including an infrared cropped image and a color cropped image, corresponding to the first cropped image and the second cropped image). Then, distortion correction processing is performed on the original cropped images, to obtain distortion-corrected images (including an infrared distortion-corrected image and a color distortion-corrected image, corresponding to the first distortion-corrected image and the second distortion-corrected image). Next, the distortion-corrected images are further cropped to obtain distortion-corrected cropped images (including an infrared distortion-corrected cropped image and a color distortion-corrected cropped image). Finally, spatial alignment is performed on the two distortion-corrected cropped images to obtain a final spatially aligned image, namely, a final effective FOV image.

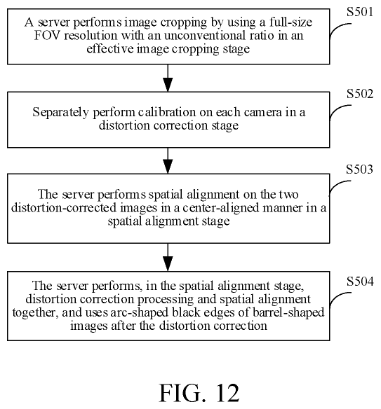

Based on the spatial alignment method, an embodiment of the present disclosure further provides a method for optimizing an effective palm-scanning FOV of a camera in the field of palm scanning. The method for optimizing an effective palm-scanning FOV of a camera is also a spatial alignment method. As shown in FIG. 12, the method includes the following operation S501 to operation S505:

Operation S501: A server performs image cropping by using a full-size FOV resolution with an unconventional ratio in an effective image cropping stage.

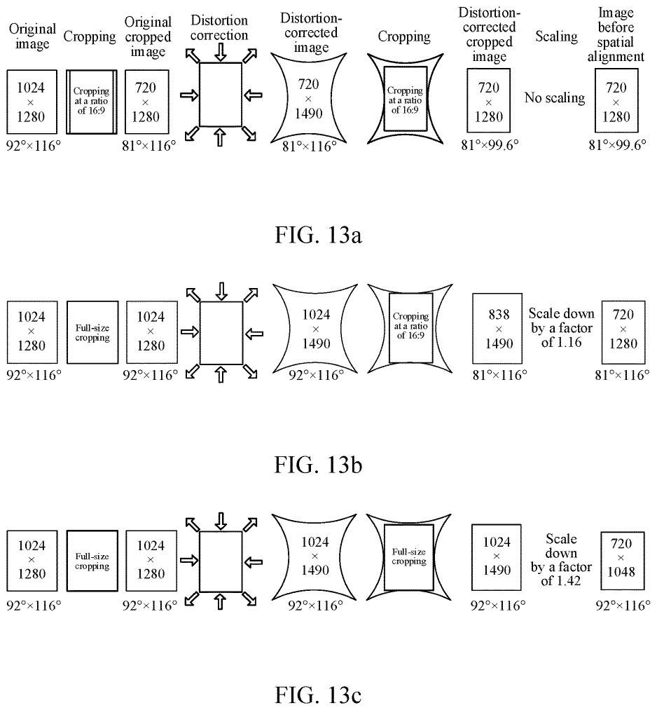

In this embodiment of the present disclosure, as shown in FIG. 13a, effective image cropping of a conventional ratio (for example, a conventional ratio such as a 16:9 ratio or a 4:3 ratio) is not performed at the stages of effective image cropping and distortion correction of the original images, that is, spatial alignment is not performed by using the procedure in FIG. 13a; otherwise, an FOV loss is caused. As shown in FIG. 13a, effective image cropping with a 16:9 ratio is performed in both the effective image cropping and distortion correction stages of the original images, resulting in an FOV loss in both transverse and longitudinal directions of the final spatially aligned image (with an FOV of 81°×99.6°) relative to the original images (with an FOV of 92°×116°).

Moreover, in this embodiment of the present disclosure, effective image cropping with a 16:9 ratio is not performed in the distortion correction stage either, i.e., spatial alignment is not performed by using the procedure in FIG. 13b; otherwise, the foregoing FOV loss will be caused. As shown in FIG. 13 b, effective image cropping with a 16:9 ratio is performed in the distortion correction stage of the original images, resulting in a transverse FOV loss of the final spatially aligned image (with an FOV of 81°×116°) relative to the original images (with an FOV of 92°×116°).

In this embodiment of the present disclosure, effective image cropping may be performed according to a full-size FOV resolution with an unconventional ratio, i.e., spatial alignment is performed by using the procedure in FIG. 13c, so that a full-size FOV can be obtained. As shown in FIG. 13c, effective image cropping with a full-size unconventional ratio is performed in both the effective image cropping and distortion correction stages of the original images, thereby ensuring that there is no FOV loss of the final spatially aligned image (with an FOV of 92°×116°) relative to the original images (with an FOV of 92°×116°).

Operation S502: Separately perform calibration on each camera in a distortion correction stage.

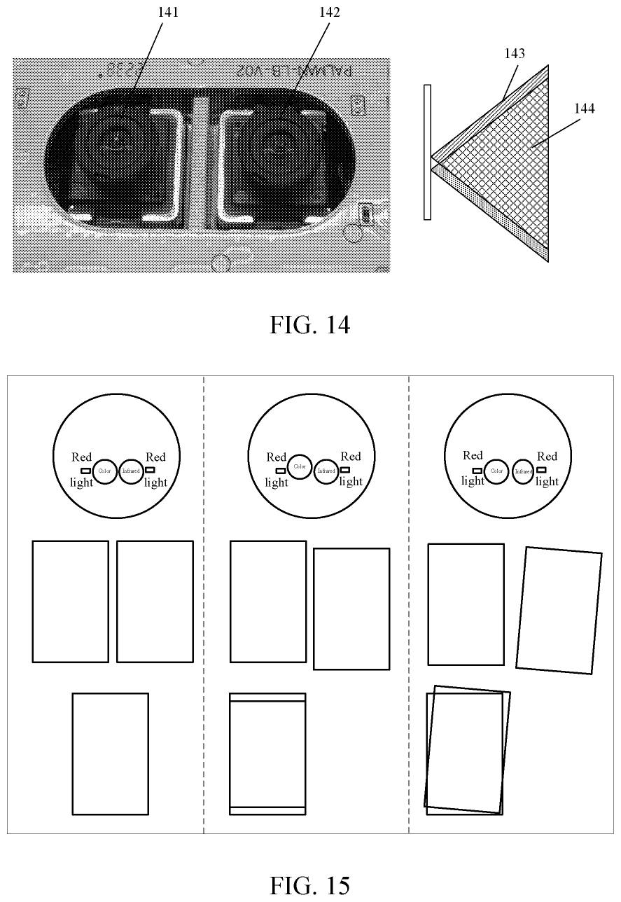

As shown in FIG. 14, during factory production, factors such as design tolerance, stress, torsion, glue characteristics, and gluing process may cause a problem that two cameras (a camera 141 and a camera 142 in FIG. 14) are not aligned in a vertical direction. As shown on the right side of FIG. 14, a vertical FOV 143 of the camera 141 is not completely aligned with a vertical FOV 144 of the camera 142. Generally, a golden unit calibration method is adopted to address such misalignment problems, and a set of calibrated parameters is adapted to all devices (i.e., infrared cameras and color cameras). Although such a method is simple, random deviations are likely to occur, as shown in FIG. 15. In addition, a buffer space of 14° may be set at an upper layer based on an online sample empirical value. This may also cause damage to an available FOV. Since a deviation of each device is highly random, a more suitable solution is to calibrate each device separately. Specifically, in this embodiment of the present disclosure, a method of calibrating each camera separately is adopted in the distortion correction stage, so that a more accurate coordinate system can be provided for the upper layer, thereby removing a buffer space limit. In an implementation process, a set of calibration tools (i.e., preset calibration tools) and calibration standards (for example, a set of camera calibration standard values) may be designed to calibrate each camera, so as to obtain device intrinsic parameters of each camera for distortion correction processing in the distortion correction stage, and then distortion correction processing can be performed on original images based on the device intrinsic parameters.

Operation S503: The server performs spatial alignment on the two distortion-corrected images in a center-aligned manner in a spatial alignment stage.

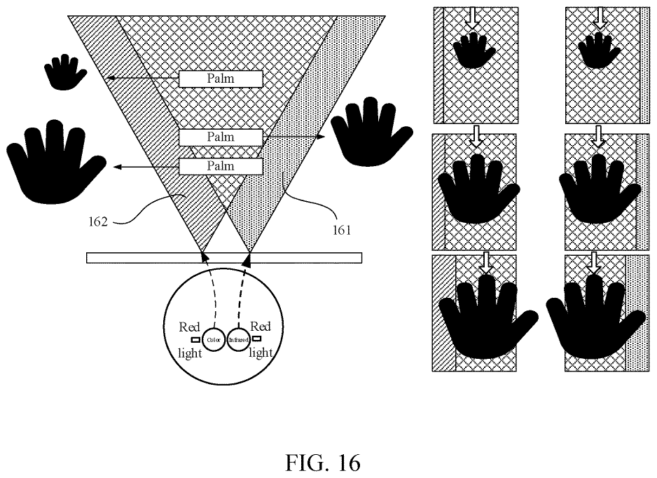

As shown in FIG. 16, FIG. 16 is a schematic diagram of lateral loss analysis according to an embodiment of the present disclosure. For an infrared camera and a color camera, an FOV loss occurs if FOVs of two cameras (an FOV 161 of an infrared camera and an FOV 162 of a color camera in FIG. 16) do not intersect. However, an available intersection region (i.e., an intersection region of the FOV 161 of the infrared camera and the FOV 162 of the color camera) varies with a distance between a palm and the cameras: a shorter distance results in a smaller intersection region and a greater FOV loss, and a longer distance results in a larger intersection region and a smaller FOV loss. The palm has different relative positions in the color image and the infrared image. Spatial alignment needs to be performed, which also causes an FOV loss.

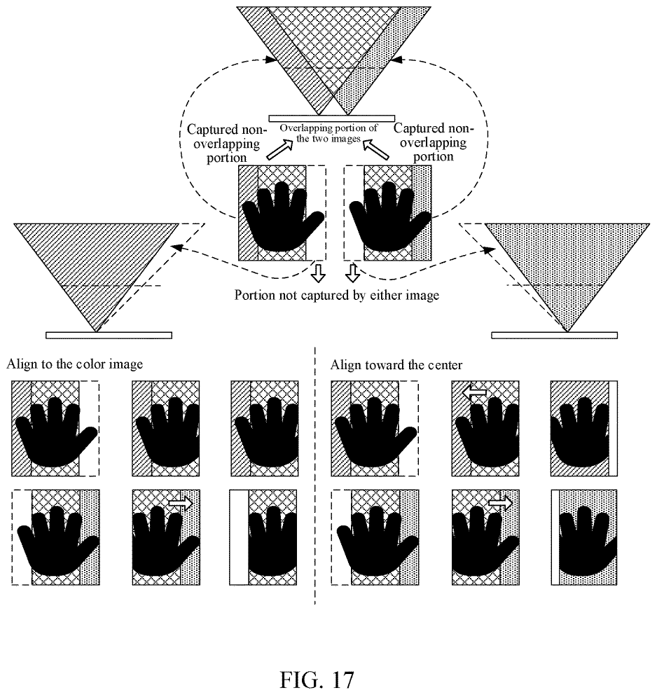

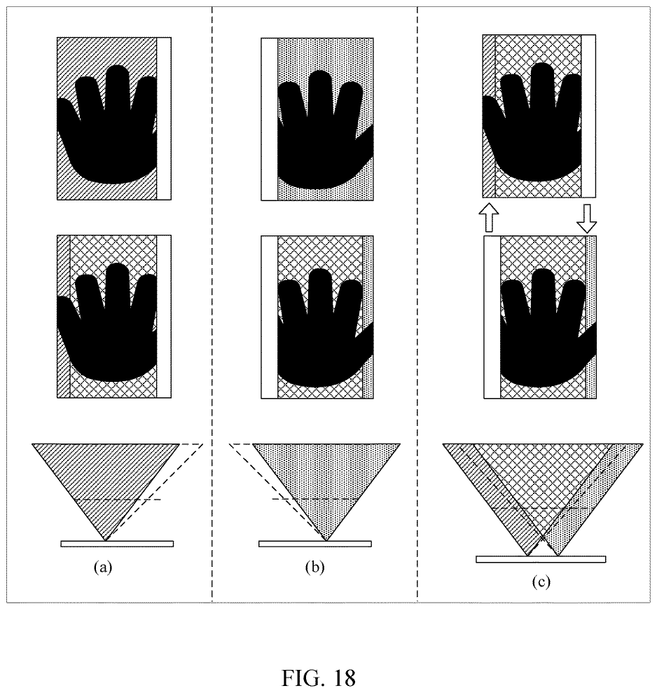

In scenarios such as face recognition, usage distances are basically above 30 cm, and FOV is almost unaffected at a long distance. Therefore, alignment is basically performed toward the color image, as shown in a schematic diagram of comparison between alignment toward a color image and centering alignment in FIG. 17. However, palm scanning is usually a short-distance scenario (a distance between the palm and the cameras is about 5 cm to 8 cm). If alignment is performed toward a specific image, the FOV loss problem will be more obvious (for example, alignment toward the color image will cause more loss of a non-intersecting part of the infrared image). Therefore, a solution provided in this embodiment of the present disclosure is: aligning both images toward the center, because centering alignment is feasible due to particularities of the palm that “a lens of the color camera is the same as a lens of the infrared camera” and “the palm is a plane”.

Operation S504: The server performs, in the spatial alignment stage, distortion correction processing and spatial alignment together, and uses arc-shaped black edges of barrel-shaped images after the distortion correction.

After centering alignment, it is found that: a blank black edge part of the color image exactly corresponds to a non-intersecting photographing part of the infrared image; similarly, a blank black edge part of the infrared image exactly corresponds to a non-intersecting photographing part of the color image. If the blank black edge parts of the two images can be optimized, an effective FOV can be optimized. As shown in FIG. 18, a part (a) in FIG. 18 is a result of alignment toward the color image, a part (b) in FIG. 18 is a result of alignment toward the infrared image, and a part (c) in FIG. 18 is a result of centering alignment of the two images. It can be seen that the effective FOV of the two images can be optimized after centering alignment.

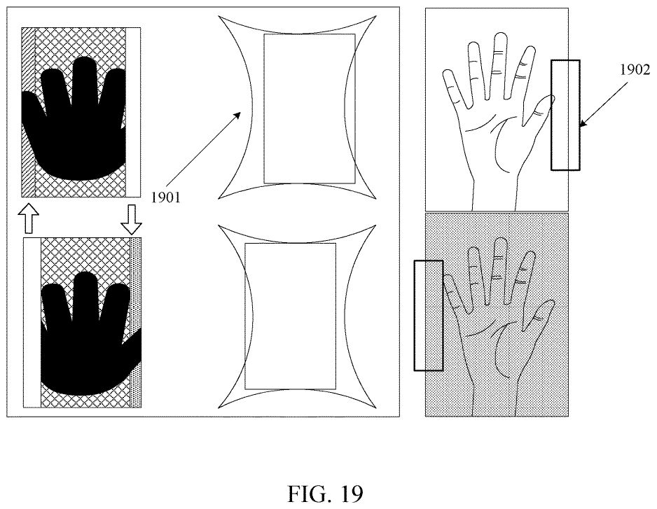

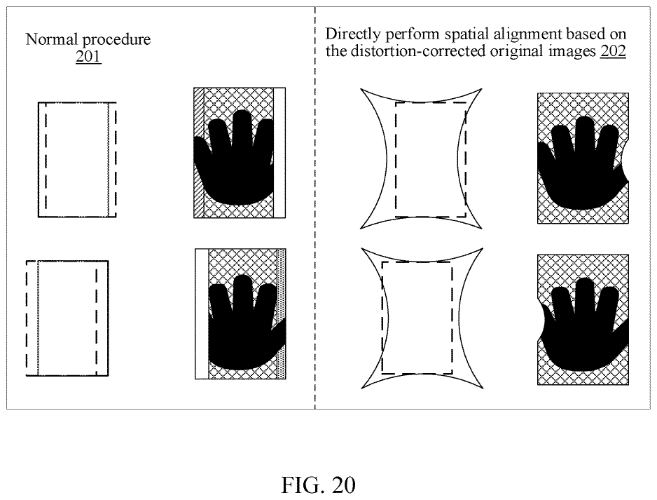

In this embodiment of the present disclosure, the effective FOV can be optimized by optimizing the blank black edge parts of the two images. It is further found that the blank black edge parts of the two images exactly correspond to arc-shaped regions after distortion correction, such as an arc-shaped region 1901 in FIG. 19; except a small black edge 1902 (i.e., an arc-shaped black edge region) in the middle, the rest of the arc-shaped regions are useful FOVs; if the blank black edge parts of the two images can be optimized, the effective FOV can be optimized, as shown in a schematic diagram of a comparison result between a normal procedure 201 and direct spatial alignment 202 based on distortion-corrected original images in FIG. 20. Therefore, based on an exploration of optimizing the blank black edge parts of the two images, the following conclusion can be drawn: In a normal procedure, the blank black edge parts of the two images directly cause an FOV loss; if “distortion correction processing and spatial alignment” are combined, a full effective FOV can be obtained, with only a small amount of FOV loss at arcs.

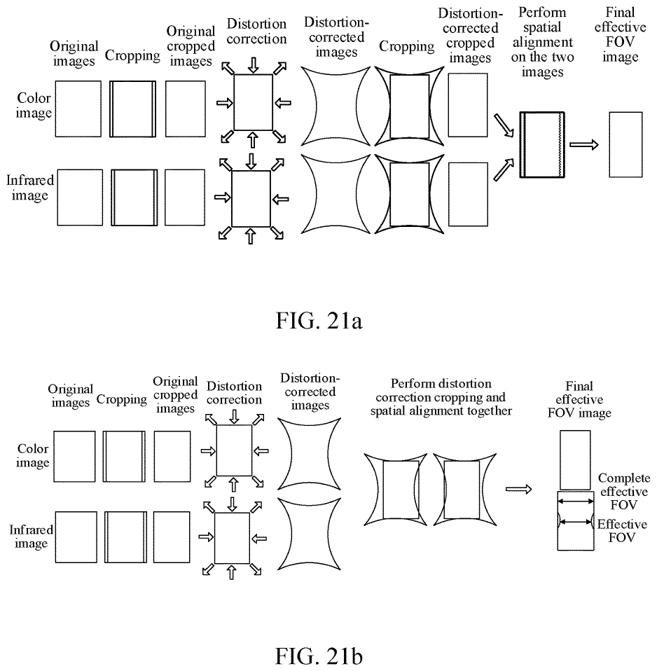

In conclusion, an embodiment of the present disclosure further provides an overall process of an image processing method for optimizing an FOV, as a process shown in FIG. 21b. A process of FIG. 21a is an overall process of the image processing method before optimization. An image processing method for optimizing an FOV combines distortion correction processing with spatial alignment, so that an almost complete FOV is still retained after spatial alignment.

Through the foregoing operations, effective FOV optimization can be completed.

According to the image processing method provided in this embodiment of the present disclosure, the effective FOV can be optimized from 76.8°×106° in the method in the related technology to 95°×116°. A palm-scanning distance can be optimized from 6.5-15 cm to 5 -15 cm. In other words, a relatively large effective FOV can be obtained at a relatively short palm-scanning distance, thereby effectively improving an effective FOV in the field of palm scanning.

The embodiments of the present disclosure involve content related to user information, for example, information such as a palm print of a user. If data related to the user information or enterprise information is involved, when the embodiments of the present disclosure are applied to a specific product or technology, it is necessary to obtain user permission or consent, or perform fuzzy processing on the information to eliminate a mapping between the information and the user. In addition, relevant data collection and processing shall strictly comply with relevant national laws and regulations during instance application, with informed consent or separate consent of a personal information subject, and subsequent data use and processing behaviors are performed within the scope of laws, regulations, and authorization of the personal information subject.

An exemplary structure in which an image processing apparatus 354 provided by an embodiment of the present disclosure is implemented as a software module is further described below. In some embodiments, as shown in FIG. 3, the image processing apparatus 354 includes: an obtaining module, configured to obtain an original image pair, the original image pair including a first original image acquired by using a first-type image acquisition device and a second original image acquired by using a second-type image acquisition device, both the first original image and the second original image including a target object; an image cropping module, configured to perform image cropping on the first original image to obtain a first cropped image, and perform image cropping on the second original image to obtain a second cropped image; a distortion correction module, configured to perform distortion correction processing on the first cropped image to obtain a first distortion-corrected image, and perform distortion correction processing on the second cropped image to obtain a second distortion-corrected image; and a spatial alignment module, configured to perform distortion-aware spatial alignment on the first distortion-corrected image and the second distortion-corrected image to obtain a spatially aligned image including the target object.

In some embodiments, the first original image is an image having barrel distortion. The distortion correction module is further configured to: perform distortion correction processing on the first cropped image having the barrel distortion to obtain a first preliminarily corrected image having a pincushion shape; and fill arc-shaped regions in the first preliminarily corrected image with black pixels to obtain the first distortion-corrected image, the first distortion-corrected image including two arc-shaped black edge regions that are formed after the distortion correction processing is performed on the first cropped image.

In some embodiments, the second original image is an image having barrel distortion. The distortion correction module is further configured to: perform distortion correction processing on the second cropped image having the barrel distortion to obtain a second preliminarily corrected image having a pincushion shape; and fill arc-shaped regions in the second preliminarily corrected image with black pixels to obtain the second distortion-corrected image, the second distortion-corrected image including two arc-shaped black edge regions that are formed after the distortion correction processing is performed on the second cropped image.

In some embodiments, the distortion-aware spatial alignment includes spatial alignment and image cropping. The spatial alignment module is further configured to: perform spatial alignment on the first distortion-corrected image and the second distortion-corrected image in a center-aligned manner to obtain a spatially aligned overlapping image; and perform image cropping on the spatially aligned overlapping image to obtain the spatially aligned image including the target object.

In some embodiments, the spatial alignment module is further configured to: determine a first object center line of the target object in the first distortion-corrected image, and determine a second object center line of the target object in the second distortion-corrected image; and determine a relative positional relationship between the first distortion-corrected image and the second distortion-corrected image; determine, based on the relative positional relationship, a first distance between a first image edge of the first distortion-corrected image and the first object center line and a second distance between a second image edge of the second distortion-corrected image and the second object center line, the first image edge being an edge that is away from the second distortion-corrected image and that is determined based on the relative positional relationship, and the second image edge being an edge that is away from the first distortion-corrected image and that is determined based on the relative positional relationship; and perform spatial alignment on the first distortion-corrected image and the second distortion-corrected image based on the first distance and the second distance to obtain the spatially aligned overlapping image.

In some embodiments, the spatial alignment module is further configured to: determine a first alignment direction of the first distortion-corrected image and a second alignment direction of the second distortion-corrected image according to the relative positional relationship, the first alignment direction being opposite to the second alignment direction; determine a first movement distance of the first distortion-corrected image based on the first distance and the second distance; determine a second movement distance of the second distortion-corrected image based on the first distance and the second distance; and move the first distortion-corrected image along the first alignment direction according to the first movement distance, and move the second distortion-corrected image along the second alignment direction according to the second movement distance, to obtain the spatially aligned overlapping image.

In some embodiments, the spatial alignment module is further configured to: determine a first center line of the first distortion-corrected image and a second center line of the second distortion-corrected image; and perform spatial alignment on the first distortion-corrected image having the arc-shaped black edge regions and the second distortion-corrected image having the arc-shaped black edge regions based on the first center line and the second center line, to obtain the spatially aligned overlapping image.

In some embodiments, the first original image is an image having pincushion distortion. The distortion correction module is further configured to: perform distortion correction processing on the first cropped image having the pincushion distortion to obtain a first preliminarily corrected image having a barrel shape; and fill arc-shaped regions in the first preliminarily corrected image with black pixels to obtain the first distortion-corrected image, the first distortion-corrected image including four arc-shaped black edge regions that are formed after the distortion correction processing is performed on the first cropped image.

In some embodiments, the second original image is an image having pincushion distortion. The distortion correction module is further configured to: perform distortion correction processing on the second cropped image having the pincushion distortion to obtain a second preliminarily corrected image having a barrel shape; and fill arc-shaped regions in the second preliminarily corrected image with black pixels to obtain the second distortion-corrected image, the second distortion-corrected image including four arc-shaped black edge regions that are formed after the distortion correction processing is performed on the second cropped image.

In some embodiments, the image cropping module is further configured to perform full-size effective image cropping on the first original image by using a specific cropping ratio, to obtain the first cropped image.

In some embodiments, the image cropping module is further configured to perform full-size effective image cropping on the second original image by using a specific cropping ratio, to obtain the second cropped image.

In some embodiments, the distortion correction module is further configured to: obtain first device intrinsic parameters of the first-type image acquisition device; obtain a first distortion coefficient of the first-type image acquisition device from the first device intrinsic parameters; and perform distortion correction processing on the first cropped image by using the first distortion coefficient, to obtain the first distortion-corrected image.

In some embodiments, the distortion correction module is further configured to: obtain second device intrinsic parameters of the second-type image acquisition device; obtain a second distortion coefficient of the second-type image acquisition device from the second device intrinsic parameters; and perform distortion correction processing on the second cropped image by using the second distortion coefficient, to obtain the second distortion-corrected image.

In some embodiments, the distortion correction module is further configured to: obtain preset camera calibration standard values; and independently calibrate the first-type image acquisition device by using a preset calibration tool and based on the camera calibration standard values, to obtain the first device intrinsic parameters of the first-type image acquisition device.

In some embodiments, the distortion correction module is further configured to: obtain preset camera calibration standard values; and independently calibrate the second-type image acquisition device by using a preset calibration tool and based on the camera calibration standard values, to obtain the second device intrinsic parameters of the second-type image acquisition device.

In some embodiments, the first-type image acquisition device is an infrared camera, and the second-type image acquisition device is a color camera; the first original image is an infrared image, and the second original image is a color image.

Descriptions of the apparatus embodiments are similar to the descriptions of the foregoing method embodiments. The apparatus embodiments have beneficial effects similar to those of the method embodiments and therefore are not repeatedly described. For technical details undisclosed in the apparatus embodiments of the present disclosure, refer to descriptions in the method embodiments of the present disclosure.

An embodiment of the present disclosure provides a computer program product. The computer program product includes executable instructions that are computer instructions. The executable instructions are stored in a computer-readable storage medium. When a processor of an electronic device reads the executable instructions from the computer-readable storage medium, and executes the executable instructions, the electronic device is caused to perform the foregoing image processing method in the embodiments of the present disclosure.

An embodiment of the present disclosure provides a storage medium having executable instructions stored therein. When the executable instructions are executed by a processor, the processor is caused to perform the method provided in the embodiments of the present disclosure, for example, the method shown in FIG. 4. In some embodiments, the storage medium may be a computer-readable storage medium, and the computer-readable storage medium may be a memory such as a ferromagnetic random access memory (FRAM), a read only memory (ROM), a programmable read-only memory (PROM), an erasable programmable read only memory (EPROM), an electrically erasable programmable read only memory (EEPROM), a flash memory, a magnetic surface memory, an optical disc, or a compact disk-read only memory (CD-ROM); or may be various devices including one or any combination of the foregoing memories.

In some embodiments, the executable instructions may be written in a form of a program, software, a software module, a script, or code and according to a programming language (including a compiled or interpreted language or a declarative or procedural language) in any form, and may be deployed in any form, including an independent program or a module, a component, a subroutine, or another unit suitable for use in a computing environment.

For example, the executable instructions may, but do not necessarily, correspond to files in a file system, and may be stored as a part of a file that saves another program or other data, for example, stored in one or more scripts in a HyperText Markup Language (HTML) file, stored in a single file dedicated to a program in discussion, or stored in a plurality of collaborative files (for example, files storing one or more modules, subprograms, or code parts). For example, the executable instructions may be deployed to be executed on an electronic device, or deployed to be executed on a plurality of electronic devices at one location, or deployed to be executed on a plurality of electronic devices that are distributed at a plurality of locations and interconnected by using a communication network.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

As disclosed herein, the embodiments of the present disclosure provide at least the following beneficial effects. When performing spatial alignment on an original image pair, the electronic device sequentially performs effective image cropping and distortion correction processing on a first original image and also sequentially performs effective image cropping and distortion correction processing on a second original image, to obtain a first distortion-corrected image and a second distortion-corrected image. Then, distortion-aware spatial alignment is performed on the first distortion-corrected image and the second distortion-corrected image to obtain a spatially aligned image including a target object. Distortion-aware spatial alignment is performed on the first distortion-corrected image and the second distortion-corrected image, thereby simultaneously realizing distortion correction and spatial alignment on the first distortion-corrected image and the second distortion-corrected image. In this way, it can be ensured that during image cropping, non-intersecting photographing parts of the first original image and the second original image are not excessively cropped; in other words, an effective FOV of the original image pair is not cropped off. Therefore, the method according to the embodiments of the present disclosure can optimize the effective FOV of the original image pair captured by the first-type image acquisition device and the second-type image acquisition device while ensuring an alignment effect of the original image pair.

The foregoing descriptions are merely embodiments of the present disclosure, but are not intended to limit the protection scope of the present disclosure. Any modification, equivalent replacement, improvement, and the like made within the spirit and scope of the present disclosure are included in the protection scope of the present disclosure.

What is claimed is:

1. An image processing method, executed by an electronic device, the method comprising:
obtaining an original image pair, the original image pair comprising a first original image acquired by a first-type image acquisition device and a second original image acquired by a second-type image acquisition device, and both the first original image and the second original image comprising a target object;
performing image cropping on the first original image to obtain a first cropped image, and performing image cropping on the second original image to obtain a second cropped image;
performing distortion correction processing on the first cropped image to obtain a first distortion-corrected image, and performing distortion correction processing on the second cropped image to obtain a second distortion-corrected image; and
performing distortion-aware spatial alignment on the first distortion-corrected image and the second distortion-corrected image to obtain a spatially aligned image comprising the target object.

2. The method according to claim 1, wherein the first original image is an image having barrel distortion; and
performing the distortion correction processing on the first cropped image to obtain the first distortion-corrected image comprises:
performing distortion correction processing on the first cropped image having the barrel distortion to obtain a first preliminarily corrected image having a pincushion shape; and
filling arc-shaped regions in the first preliminarily corrected image with black pixels to obtain the first distortion-corrected image, the first distortion-corrected image comprising two arc-shaped black edge regions that are formed after the distortion correction processing is performed on the first cropped image.

3. The method according to claim 1, wherein the second original image is an image having barrel distortion; and
performing the distortion correction processing on the second cropped image to obtain the second distortion-corrected image comprises:
performing distortion correction processing on the second cropped image having the barrel distortion to obtain a second preliminarily corrected image having a pincushion shape; and
filling arc-shaped regions in the second preliminarily corrected image with black pixels to obtain the second distortion-corrected image, the second distortion-corrected image comprising two arc-shaped black edge regions that are formed after the distortion correction processing is performed on the second cropped image.

4. The method according to claim 1, wherein the distortion-aware spatial alignment comprises spatial alignment and image cropping; and performing distortion-aware spatial alignment on the first distortion-corrected image and the second distortion-corrected image to obtain the spatially aligned image comprising the target object comprises:
performing spatial alignment on the first distortion-corrected image and the second distortion-corrected image in a center-aligned manner to obtain a spatially aligned overlapping image; and
performing image cropping on the spatially aligned overlapping image to obtain the spatially aligned image comprising the target object.

5. The method according to claim 4, wherein performing the spatial alignment on the first distortion-corrected image and the second distortion-corrected image in the center-aligned manner to obtain the spatially aligned overlapping image comprises:
determining a first object center line of the target object in the first distortion-corrected image, and determining a second object center line of the target object in the second distortion-corrected image;
determining a relative positional relationship between the first distortion-corrected image and the second distortion-corrected image;
determining, based on the relative positional relationship, a first distance between a first image edge of the first distortion-corrected image and the first object center line and a second distance between a second image edge of the second distortion-corrected image and the second object center line, the first image edge being an edge that is away from the second distortion-corrected image and that is determined based on the relative positional relationship, and the second image edge being an edge that is away from the first distortion-corrected image and that is determined based on the relative positional relationship; and
performing spatial alignment on the first distortion-corrected image and the second distortion-corrected image based on the first distance and the second distance to obtain the spatially aligned overlapping image.

6. The method according to claim 5, wherein performing the spatial alignment on the first distortion-corrected image and the second distortion-corrected image based on the first distance and the second distance to obtain the spatially aligned overlapping image comprises:
determining a first alignment direction of the first distortion-corrected image and a second alignment direction of the second distortion-corrected image according to the relative positional relationship, the first alignment direction being opposite to the second alignment direction;
determining a first movement distance of the first distortion-corrected image based on the first distance and the second distance;
determining a second movement distance of the second distortion-corrected image based on the first distance and the second distance; and
moving the first distortion-corrected image along the first alignment direction according to the first movement distance, and moving the second distortion-corrected image along the second alignment direction according to the second movement distance, to obtain the spatially aligned overlapping image.

7. The method according to any one of claims 1 to 6, wherein performing the spatial alignment on the first distortion-corrected image and the second distortion-corrected image in the center-aligned manner to obtain the spatially aligned overlapping image comprise:
determining a first center line of the first distortion-corrected image and a second center line of the second distortion-corrected image; and
performing spatial alignment on the first distortion-corrected image having the arc-shaped black edge regions and the second distortion-corrected image having the arc-shaped black edge regions based on the first center line and the second center line, to obtain the spatially aligned overlapping image.

8. The method according to claim 1, wherein the first original image is an image having pincushion distortion; and
performing the distortion correction processing on the first cropped image to obtain the first distortion-corrected image comprises:
performing distortion correction processing on the first cropped image having the pincushion distortion to obtain a first preliminarily corrected image having a barrel shape; and
filling arc-shaped regions in the first preliminarily corrected image with black pixels to obtain the first distortion-corrected image, the first distortion-corrected image comprising four arc-shaped black edge regions that are formed after the distortion correction processing is performed on the first cropped image.

9. The method according to claim 1, wherein the second original image is an image having pincushion distortion; and
performing the distortion correction processing on the second cropped image to obtain the second distortion-corrected image comprises:
performing distortion correction processing on the second cropped image having the pincushion distortion to obtain a second preliminarily corrected image having a barrel shape; and
filling arc-shaped regions in the second preliminarily corrected image with black pixels to obtain the second distortion-corrected image, the second distortion-corrected image comprising four arc-shaped black edge regions that are formed after the distortion correction processing is performed on the second cropped image.

10. The method according to claim 1, wherein performing the image cropping on the first original image to obtain the first cropped image comprises:
performing full-size effective image cropping on the first original image by a specific cropping ratio, to obtain the first cropped image.

11. The method according to claim 1, wherein performing the image cropping on the second original image to obtain the second cropped image comprises:
performing full-size effective image cropping on the second original image by a specific cropping ratio, to obtain the second cropped image.

12. The method according to claim 1, wherein performing the distortion correction processing on the first cropped image to obtain the first distortion-corrected image comprises:
obtaining first device intrinsic parameters of the first-type image acquisition device;
obtaining a first distortion coefficient of the first-type image acquisition device from the first device intrinsic parameters; and
performing distortion correction processing on the first cropped image by the first distortion coefficient, to obtain the first distortion-corrected image.

13. The method according to claim 1, wherein performing the distortion correction processing on the second cropped image, to obtain the second distortion-corrected image comprises:
obtaining second device intrinsic parameters of the second-type image acquisition device;
obtaining a second distortion coefficient of the second-type image acquisition device from the second device intrinsic parameters; and
performing distortion correction processing on the second cropped image by the second distortion coefficient, to obtain the second distortion-corrected image.

14. The method according to claim 12, wherein obtaining the first device intrinsic parameters of the first-type image acquisition device comprises:
obtaining preset camera calibration standard values; and
independently calibrating the first-type image acquisition device by a preset calibration tool and based on the camera calibration standard values, to obtain the first device intrinsic parameters of the first-type image acquisition device.

15. The method according to claim 13, wherein obtaining the second device intrinsic parameters of the second-type image acquisition device comprises:
obtaining preset camera calibration standard values; and
independently calibrating the second-type image acquisition device by a preset calibration tool and based on the camera calibration standard values, to obtain the second device intrinsic parameters of the second-type image acquisition device.

16. The method according to claim 1, wherein
the first-type image acquisition device is an infrared camera, and the second-type image acquisition device is a color camera; and
the first original image is an infrared image, and the second original image is a color image.

17. An electronic device, comprising:
one or more processors and a memory containing executable instructions that, when being executed, cause the one or more processors to perform:
obtaining an original image pair, the original image pair comprising a first original image acquired by a first-type image acquisition device and a second original image acquired by a second-type image acquisition device, and both the first original image and the second original image comprising a target object;
performing image cropping on the first original image to obtain a first cropped image, and performing image cropping on the second original image to obtain a second cropped image;
performing distortion correction processing on the first cropped image to obtain a first distortion-corrected image, and performing distortion correction processing on the second cropped image to obtain a second distortion-corrected image; and
performing distortion-aware spatial alignment on the first distortion-corrected image and the second distortion-corrected image to obtain a spatially aligned image comprising the target object.

18. The electronic device according to claim 17, wherein the first original image is an image having barrel distortion; and
the one or more processors are further configured to perform:
performing distortion correction processing on the first cropped image having the barrel distortion to obtain a first preliminarily corrected image having a pincushion shape; and
filling arc-shaped regions in the first preliminarily corrected image with black pixels to obtain the first distortion-corrected image, the first distortion-corrected image comprising two arc-shaped black edge regions that are formed after the distortion correction processing is performed on the first cropped image.

19. The electronic device according to claim 17, wherein the second original image is an image having barrel distortion; and
the one or more processors are further configured to perform:
performing distortion correction processing on the second cropped image having the barrel distortion to obtain a second preliminarily corrected image having a pincushion shape; and
filling arc-shaped regions in the second preliminarily corrected image with black pixels to obtain the second distortion-corrected image, the second distortion-corrected image comprising two arc-shaped black edge regions that are formed after the distortion correction processing is performed on the second cropped image.

20. A non-transitory computer-readable storage medium containing executable instructions that, when being executed, cause at least one processor to perform:
obtaining an original image pair, the original image pair comprising a first original image acquired by a first-type image acquisition device and a second original image acquired by a second-type image acquisition device, and both the first original image and the second original image comprising a target object;
performing image cropping on the first original image to obtain a first cropped image, and performing image cropping on the second original image to obtain a second cropped image;
performing distortion correction processing on the first cropped image to obtain a first distortion-corrected image, and performing distortion correction processing on the second cropped image to obtain a second distortion-corrected image; and
performing distortion-aware spatial alignment on the first distortion-corrected image and the second distortion-corrected image to obtain a spatially aligned image comprising the target object.
